(19) United States
(12) Patent Application Publication
(10) Pub. No.: US 2016/0004710 A1
(43) Pub. Date: Jan. 7, 2016

(54) WORK LOG EDITING METHOD AND INFORMATION PROCESSING APPARATUS

(71) Applicant: FUJITSU LIMITED, Kawasaki-shi (JP)

(72) Inventors: Atsuji SEKIGUCHI, Kawasaki (JP); Toshihiro SHIMIZU, Sagamihara (JP); Takeshi Yasuie, Kawasaki (JP)

(21) Appl. No.: 14/741,541

(22) Filed: Jun. 17, 2015

(30) Foreign Application Priority Data
Jul. 4, 2014 (JP) 2014-138320

(51) Int. Cl. G06F 17/30

(52) U.S. Cl. CPC G06F 17/30082

(57) ABSTRACT

A memory unit of an information processing apparatus acquires at least one operation log in work performed on a management target device and difference information indicating a difference between a file before edit and the file after edit that is edited using an editing software. A computing unit extracts a first log indicating an activation operation of the editing software used in editing the file, from the log. Then, the computing unit replaces the first log with a second log indicating an operation for reflecting in the file the difference indicated in the difference information.

### CROSS-REFERENCE TO RELATED APPLICATION

This application is based upon and claims the benefit of priority of the prior Japanese Patent Application No. 2014-138320, filed on Jul. 4, 2014, the entire contents of which are incorporated herein by reference.

### FIELD

The embodiments discussed herein relate to a work log editing method and an information processing apparatus.

### BACKGROUND

In operation and management of a system, such as an information and communication technology (ICT) system, system configurations of operating system (OS) and middleware are changed by installation, version upgrade, and the like in some cases. For example, work, such as activation and halt of a system, change of set values of a system, and software update, is performed to change system configurations. At this, if an administrator devises a work procedure from scratch each time such work is to be performed, the work efficiency is low, and an error is more likely to occur.

Thus, some researchers are considering creating a work procedure that can be executed in an operation target system, utilizing existing work procedures. For example, some researchers are considering a technology that acquires information of how operators operate and creates an operation procedure for the operation target system and a guidance for informing how to operate, on the basis of the acquired operation information, when an operation task is to be performed. Also, some researchers are considering a technology that collects logs from a log database, and collects operation setting information from an operation registration database, and analyzes the collected logs and operation setting information to optimize a remote operation. Further, there is a technology that outputs procedure information including unique information set according to a change target system, on the basis of a collection of procedure information indicating a work procedure for changing configuration according to system configuration change. This makes the work for changing a system configuration more efficient.

See, for example, Japanese Laid-open Patent Publication Nos. 2013-190901 and 2007-328526, and International Publication Pamphlet No. WO 2012/124018.

However, when an operation performed in an operation task includes an edit operation that edits a file using an application software, such as an editor, information of how the edit operation is performed is unable to be acquired. Hence, it is unable to reproduce the edit operation automatically, and therefore it is unable to create a work procedure that reutilizes file edit operations, when creating a new work procedure utilizing existing work procedures.

### SUMMARY

According to one aspect, there is provided a work log editing method including: acquiring at least one operation log in work performed on a management target device and difference information indicating a difference between a file before edit and the file after edit that is edited using an editing software; extracting, by a processor, a first log indicating an activation operation of the editing software that is used in editing the file, from the operation log; and replacing, by the processor, the first log with a second log indicating an operation for reflecting in the file the difference indicated in the difference information.

The object and advantages of the invention will be configured and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration of a system according to a first embodiment;

FIG. 2 illustrates an exemplary system configuration of a second embodiment;

FIG. 3 illustrates an exemplary configuration of computer hardware used in the present embodiment;

FIG. 4 illustrates an example of a linking process;

FIG. 5 illustrates an example of procedure search;

FIG. 6 is a block diagram of functions of each device;

FIG. 7 is a sequence diagram illustrating an example of a process sequence of work procedure reutilization of the second embodiment;

FIG. 8 illustrates a log output example including prompt character strings;

FIG. 9 illustrates an example of a log in response to an input of an operator;

FIG. 10 illustrates an example of a log relevant to an input-output file;

FIG. 11 illustrates an example of an input-output file list;

FIG. 12 illustrates a log of a system call indicating an input of an operator when utilizing a tty;

FIG. 13 illustrates a log of a system call indicating an input of an operator when not utilizing a tty;

FIG. 14 illustrates an example of a copy method of a file;

FIG. 15 illustrates an example of a log of a system call indicating a file open that may cause a write;

FIG. 16 illustrates an example of a monitoring file list;

FIG. 17 illustrates an example of a log of a write system call;

FIG. 18 illustrates an example of a copy file information;

FIG. 19 illustrates an example of a log of a close system call;

FIG. 20 illustrates an example of creation of a difference file;

FIG. 21 is a flowchart illustrating an example of a procedure of a process for transmitting a work log, normalization information, and a difference file;

FIG. 22 is a flowchart illustrating an example of a procedure of a file information recording process;

FIG. 23 is a flowchart illustrating an example of a procedure of an information saving process;

FIG. 24 is a flowchart illustrating an example of a procedure of a hook process;

FIG. 25 illustrates an example of work logs in a log database;

FIG. 26 illustrates an example of difference files in a difference file database;

FIG. 27 illustrates an example of normalization information in a normalization information database;

FIG. 28 illustrates an example of rewriting a description relevant to an operation;

FIG. 29 illustrates an example of rewriting a description relevant to an input file;

FIG. 30 illustrates an example of inserting a description relevant to an output file;

FIG. 31 illustrates an example of a work log after normalization;

FIG. 32 illustrates an example of a procedure of a normalization process;

FIG. 33 is a flowchart illustrating an example of a process sequence of work procedure reutilization of a third embodiment;

FIG. 34 illustrates an example of copying by a second copy method;

FIG. 35 is a flowchart illustrating an example of a procedure of a process for transmitting a work log, normalization information, and a difference file;

FIG. 36 is a flowchart illustrating an example of a procedure of a file information recording process;

FIG. 37 is a flowchart illustrating an example of a procedure of an information saving process;

FIG. 38 illustrates an example of a graph created from a log of an edit operation;

FIG. 39 illustrates an example of a graph after normalization; and

FIG. 40 illustrates an example of a procedure of a normalization process.

### DESCRIPTION OF EMBODIMENTS

Several embodiments will be described below with reference to the accompanying drawings, wherein like reference numerals refer to like elements throughout. Note that each embodiment may be combined with another embodiment or other embodiments unless the combined embodiments contradict each other.

### First Embodiment

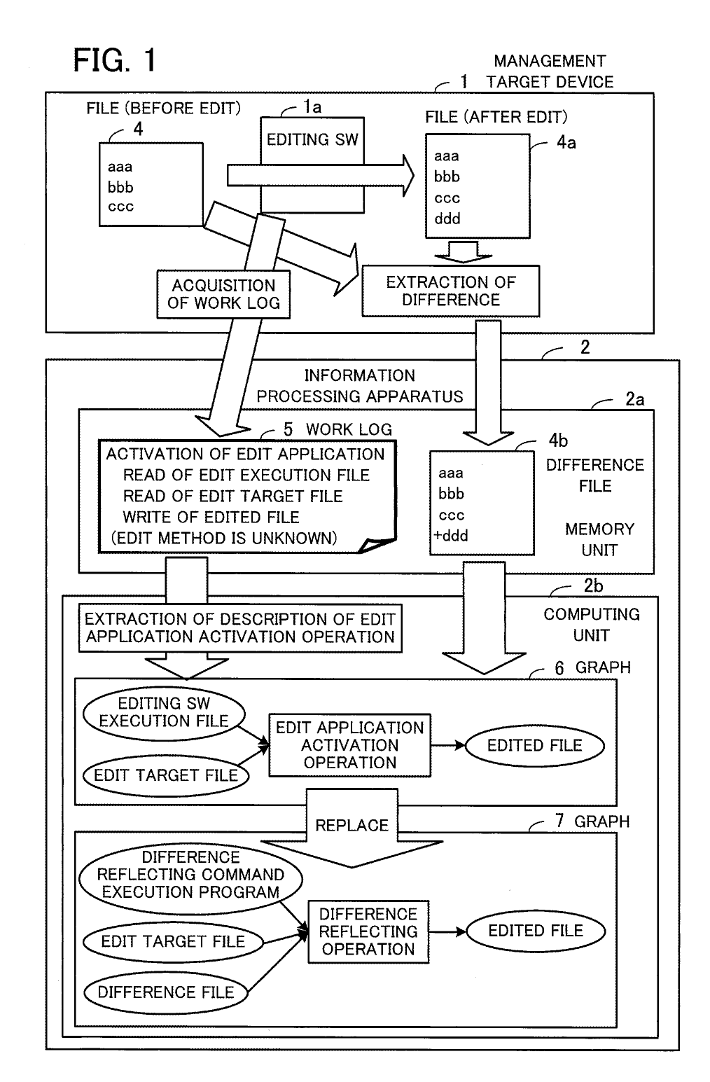

FIG. 1 illustrates an exemplary configuration of a system according to the first embodiment. The system according to the first embodiment includes a management target device 1 and an information processing apparatus 2. The management target device 1 is a computer system including one or more computers, for example. The information processing apparatus 2 is a computer system including one or more computers, for example.

The management target device 1 detects execution of an editing software (editing SW) 1a and generates difference information indicating a difference between a file 4 before edit and the file 4 after edit that is edited utilizing the editing software 1a. The difference information is included in a difference file 4b, for example. The management target device 1 transmits the difference file 4b including the difference information to the information processing apparatus 2.

Also, the management target device 1 acquires at least one operation log in work performed on the management target device 1, and transmits a work log 5 including a series of operation logs relevant to the work to the information processing apparatus 2. The performed work also includes an activation operation of the editing software 1a.

In order to detect execution of the editing software 1a, the management target device 1 monitors an input from an input device, for example. When there is an input from the input device while an activated software is executed, the management target device 1 detects the activated software as the editing software 1a.

The information processing apparatus 2 includes a memory unit 2a and a computing unit 2b. The memory unit 2a stores the work log 5 and the difference file 4b that are acquired from the management target device 1.

The computing unit 2b extracts a first log indicating an activation operation of the editing software 1a that is used in editing the file 4, from the work log 5. Then, the computing unit 2b replaces the first log with a second log indicating an operation for reflecting in the file 4 the difference indicated in the difference information of the difference file 4b. For example, when the difference information indicates that a character string “ddd” is added, the first log is replaced by the second log indicating an operation for adding the character string “ddd” to the file 4.

Also, the computing unit 2b may generate a graph 6 indicating an activation operation of the editing software from the first log and replace the first log with the graph 6. For example, the graph 6 includes nodes of a precondition, a node of an activation operation of the editing software, and a node of a postcondition. The precondition of the graph 6 indicates a state that a device that executes the editing software 1a is expected to be in. The nodes of the precondition of the graph 6 includes, for example, a node indicating a presence of an execution file of the editing software and a node indicating a presence of the file 4 of edit target. The postcondition of the graph 6 indicates a state that a device that has executed the editing software 1a is expected to be in. The node of the postcondition of the graph 6 includes, for example, a node indicating a presence of an edited file 4a.

For example, the graph 6 is replaced by a graph including nodes of a precondition, a node of an execution operation of a reflection process for reflecting a difference, and a node of a postcondition. The precondition of the graph 7 indicates a state that a device that executes the reflection process for reflecting the difference is expected to be in. For example, the nodes of the precondition of the graph 7 include a node indicating a presence of an execution program of a difference reflecting command for reflecting the difference, a node indicating a presence of the file 4, and a node indicating a presence of the difference file 4b. The postcondition of the graph 7 indicates a state that a device that has executed the reflection process for reflecting the difference is expected to be in. The node of the postcondition of the graph 7 includes, for example, a node indicating a presence of the edited file 4a.

According to this system, when work including an edit operation of the file 4 is performed on the management target device 1, the work log 5 relevant to the work is acquired and transmitted to the information processing apparatus 2. Also, in the management target device 1, difference information indicating a difference between the file 4 before edit and the file 4a after edit is generated. For example, the difference information is transmitted to the information processing apparatus 2 as the difference file 4b.

In the information processing apparatus 2, a first log relevant to an activation operation of the editing software 1a is extracted from the work log 5. Then, the extracted first log is replaced by a second log indicating an operation for reflecting in the file 4 the difference indicated in the difference information of the difference file 4b. For example, the graph 6 created on the basis of the first log is replaced by the graph 7 created on the basis of the second log.

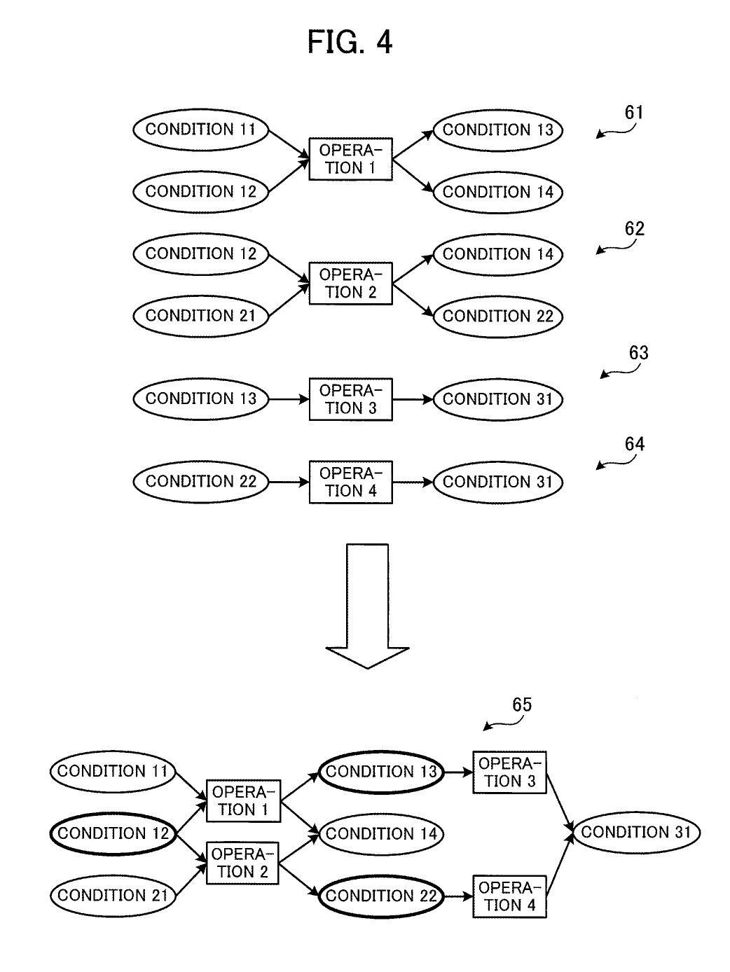

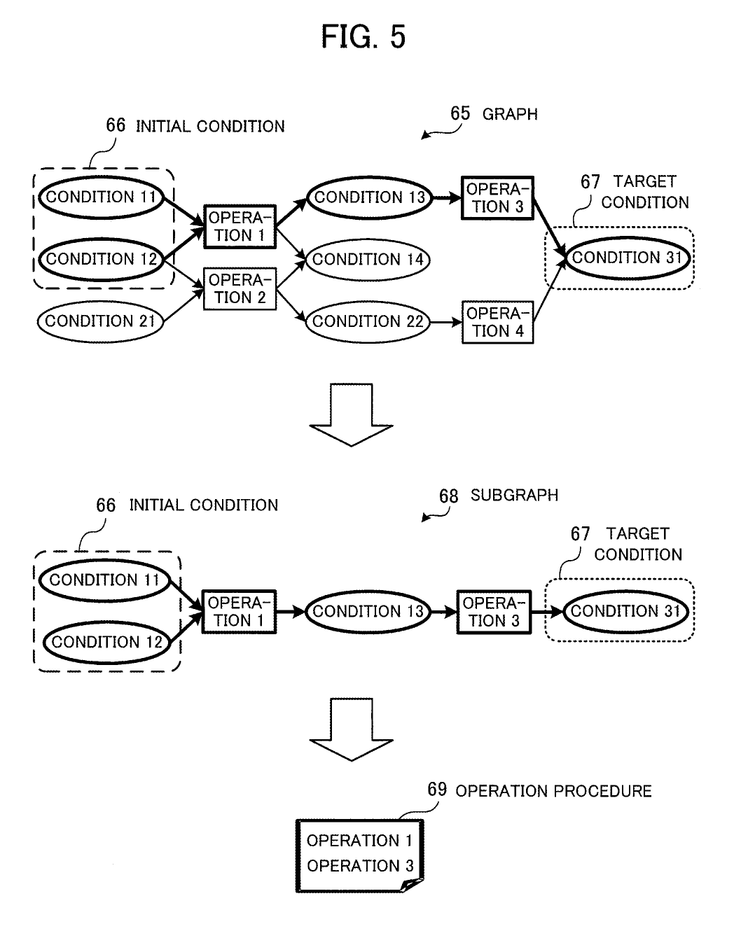

For example, when the information processing apparatus 2 creates a graph for each log of operations in the work log 5 in the same way, the information processing apparatus 2 can create a work procedure including a combination of operations, by determining a match between a precondition and a postcondition. Note that a creation method of a work procedure will be described later (refer to FIGS. 4 and 5). When creating a work procedure, the graph 6 before replacement does not include information of what an operator has input to edit a file using the editing software 1a, and therefore is unable to be utilized for creating a work procedure. On the other hand, the graph 7 after replacement includes an operation for reflecting the difference file 4b, which is prepared instead of the input from an operator, and therefore is able to be utilized when creating a work procedure. That is, the difference reflecting operation in the graph 7 is automatically executed without an input from an operator. As a result, a work procedure is created, reutilizing an edit operation of a file.

Note that the computing unit 2b is configured by a processor in the information processing apparatus 2, for example. Also, the memory unit 2a is configured by a memory in the information processing apparatus 2, for example.

Also, lines that connect between elements in FIG. 1 illustrate a part of communication routes, and communication routes other than these depicted communication routes are also usable.

### Second Embodiment

Next, the second embodiment will be described. The second embodiment automatically generates a work procedure for individual servers, by collecting work logs from a large number of servers. In the generation of a work procedure, a log relevant to edit operation is rewritten into an operation log for automatically reflecting an edit on a file.

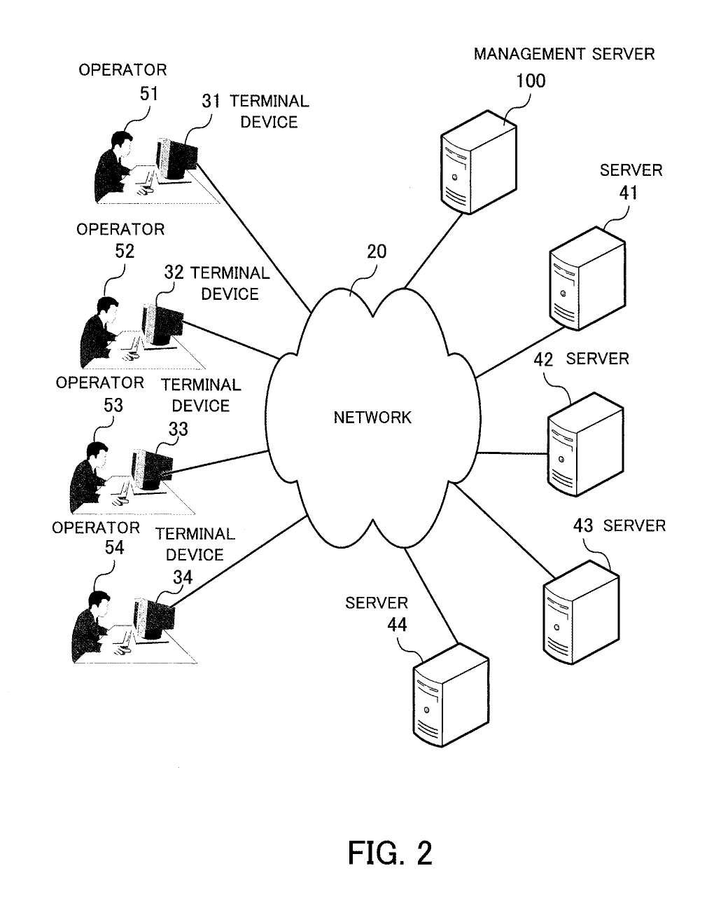

FIG. 2 illustrates an exemplary system configuration of the second embodiment. In the second embodiment, a management server 100 is provided as one example of the information processing apparatus 2 of the first embodiment illustrated in FIG. 1. The management server 100 is connected to a plurality of servers 41 to 44 via a network 20. The servers 41 to 44 each include a server, a storage device, and a network switch, for example.

Also, the network 20 is connected to terminal devices 31 to 34, which are used by a plurality of operators 51 to 54, respectively. The servers 41 to 44 are managed by different operators, respectively. Also, the servers 41 to 44 are each configured by one or more servers.

In the example of FIG. 2, the operator 51 manages the server 41 using the terminal device 31. Also, the operator 52 manages the server 42 using the terminal device 32. Also, the operator 53 manages the server 43 using the terminal device 33. Also, the operator 54 manages the server 44 using the terminal device 34.

The management server 100 is a computer for supporting operation and management of the servers 41 to 44 by the operators 51 to 54. The management server 100 acquires, from the servers 41 to 44, information of how the servers 41 to 44 are operated via the terminal devices 31 to 34 by the operators 51 to 54, and keeps it as work logs. Also, the management server 100 generates a graph indicating an operation procedure according to work task, on the basis of the work logs. Further, in response to a procedure request from the terminal devices 31 to 34 by the operators 51 to 54, the management server 100 generates an operation procedure that is executable in a server used by the operator who has issued the procedure request, and transmits the operation procedure to the terminal device that has output the procedure request.

In order to generate various operation procedures, the management server 100 divides a large number of work logs of procedures of operators into operation units, and clarifies operating conditions of operations, and generates an operation procedure by combining operations.

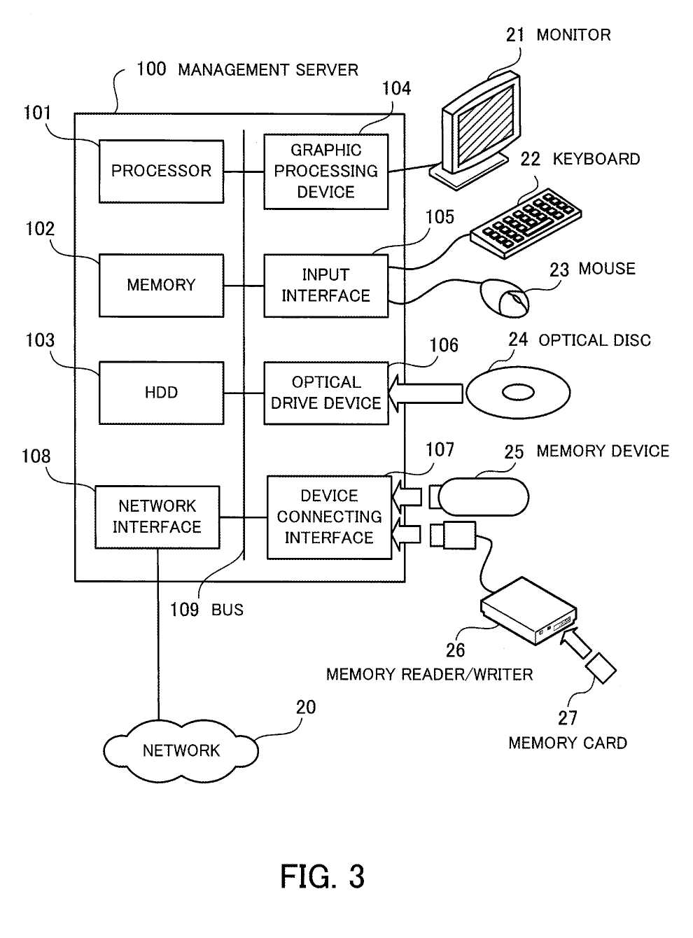

FIG. 3 illustrates an exemplary hardware configuration of the management server used in the present embodiment. Each device of the management server 100 is controlled by a processor 101. The processor 101 is connected to a memory 102 and a plurality of peripheral devices via a bus 109. The processor 101 may be a multiprocessor. The processor 101 is, for example, a central processing unit (CPU), a micro processing unit (MPU), or a digital signal processor (DSP). At least a part of functions implemented by executing programs in the processor 101 may be configured by an electronic circuit, such as an application specific integrated circuit (ASIC) or a programmable logic device (PLD).

The memory 102 is used as a main memory device of the management server 100. The memory 102 temporarily stores at least a part of OS programs and application programs executed by the processor 101. Also, the memory 102 stores various types of data used in processing by the processor 101. The memory 102 is, for example, a volatile semiconductor memory device, such as a random access memory (RAM).

The peripheral devices connected to the bus 109 include a hard disk drive (HDD) 103, a graphic processing device 104, an input interface 105, an optical drive device 106, a device connecting interface 107, and a network interface 108.

The HDD 103 magnetically writes data into, and reads data from, a built-in disk. The HDD 103 is used as an auxiliary memory device of the management server 100. The HDD 103 stores OS programs, application programs, and various types of data. Note that the auxiliary memory device may be a non-volatile semiconductor memory device, such as a flash memory.

The graphic processing device 104 is connected to a monitor 21. The graphic processing device 104 displays an image on a screen of the monitor 21 in accordance with an instruction from the processor 101. The monitor 21 is, for example, a display device using a cathode ray tube (CRT), a liquid crystal display device, or the like.

The input interface 105 is connected to a keyboard 22 and a mouse 23. The input interface 105 transmits to the processor 101 a signal sent from the keyboard 22 and the mouse 23. Note that the mouse 23 is an example of pointing device, and other pointing devices may be used. Other pointing devices are, for example, a touch panel, a tablet, a touch pad, and a trackball.

The optical drive device 106 reads data recorded in an optical disc 24, using laser light or the like. The optical disc 24 is a portable storage medium in which data is recorded in a readable manner by reflection of light. The optical disc 24 is, for example, a DVD (Digital Versatile Disc), a DVD-RAM, a CD-ROM (Compact Disc Read Only Memory), or a CD-R (Recordable)/RW (ReWritable).

The device connecting interface 107 is a communication interface for connecting the peripheral devices to the management server 100. For example, the device connecting interface 107 is connected to a memory device 25 and a memory reader/writer 26. The memory device 25 is a storage medium having a communication function with the device connecting interface 107. The memory reader/writer 26 is a device that writes data into a memory card 27 or reads data from the memory card 27. The memory card 27 is a storage medium of a card type.

The network interface 108 is connected to the network 20. The network interface 108 transmits data to, and receives data from, other computers or communication devices via the network 20.

The processing function of the second embodiment is implemented by the above hardware configuration. Note that the apparatus of the first embodiment is also configured by the same hardware as the management server 100 illustrated in FIG. 3.

The management server 100 implements the processing function of the second embodiment by executing a program recorded in a computer-readable storage medium, for example. A program describing processes executed by the management server 100 may be recorded in various storage media. For example, the program executed by the management server 100 may be stored in the HDD 103. The processor 101 loads at least a part of the program into the memory 102 from the HDD 103, and executes the program. Also, the program executed by the management server 100 may be recorded in a portable storage medium, such as an optical disc 24, a memory device 25, or a memory card 27. The program stored in the portable storage medium is executable after installed in the HDD 103 by the control from the processor 101, for example. Also, the processor 101 may read a program directly from a portable storage medium to execute the program.

The next description will explain an overview of a process for generating a work procedure for an individual server on the basis of work logs of work performed on the servers 41 to 44.

The management server 100 collects work logs from the servers 41 to 44. The management server 100 divides a series of operations indicated in the work logs, into each operation, for example. The management server 100 determines a precondition and a postcondition of each operation, on the basis of operation logs.

The precondition is a state that a system for executing a process according to operation is expected to be in. The postcondition is a state that the system that has executed the process according to operation is expected to be in. In the following, when referring to “condition” simply, it includes both of the precondition and the postcondition.

There is a precondition for each process that is executed in response to operation, for example. The precondition is, for example, a condition “a system has files that are to be read when executing a process according to operation”. In this case, a list of files that are read when executing a process according to operation is defined in the precondition.

There is a postcondition for each process according to the operation, for example. The postcondition is, for example, a condition “a system has files generated by executing a process according to operation”. In this case, a list of files generated by executing a process according to operation is defined in the postcondition.

The management server 100 determines a precondition and a postcondition of each operation, and generates condition defining information that links the precondition and the postcondition to each operation, for example. For example, a plurality of operations are each linked to operations having a precondition that is same as the postcondition of the plurality of operations. For example, the management server 100 creates a graph on the basis of conditions. A graph defines transitions from operations to operations. In this definition, each operation can be an operation before transition, and an operation after transition has a precondition that is same as the postcondition of an operation before transition. A transition from a certain operation to another operation is defined as a transition via a condition indicating a precondition or a postcondition in the graph, for example.

FIG. 4 illustrates an example of the linking process. In the example of FIG. 4, there are four operations. In this case, graphs 61 to 64 are created for the respective operations. The graphs 61 to 64 are each expressed as a combination of nodes and edges. A node is an element indicating an operation or a condition. An edge is an arrow linking between nodes, and indicates a relationship between nodes.

In the example of FIG. 4, an operation is illustrated as a rectangular node, and a condition is illustrated as an ellipsoidal node. In a node indicating an operation, an operation ID of the operation is indicated. In a node indicating a condition, a condition ID of the condition is indicated. A node of a precondition is located on the left side of a node of an operation, and a node of a postcondition is located on the right side of a node of an operation. A node of an operation is connected to nodes of a precondition and a postcondition of the operation by edges. An edge connecting between a node of a precondition and a node of an operation is an arrow pointing at the node of the operation. An edge connecting between a node of a postcondition and a node of an operation is an arrow pointing at the node of the postcondition.

In the graphs 61 to 64 of operations, same operations or same conditions are combined into one node. The graphs 61 to 64 of operations are integrated into one graph 65, by combining the same operations or conditions. In the graph 65, nodes of the condition ID “condition 12”, which are preconditions of the operation of the operation ID “operation 1” and of the operation of the operation ID “operation 2”, are combined into one node. Also, the node of the condition ID “condition 13”, which is a postconditions of the operation of the operation ID “operation 1” and the node of the condition ID “condition 13”, which is the precondition of the operation of the operation ID “operation 3”, are combined into one node. Also, the node of the condition ID “condition 22”, which is a postcondition of the operation of the operation ID “operation 2”, and the node of the condition ID “condition 22”, which is the precondition of the operation of the operation ID “operation 4”, are combined into one node. A procedure can be searched, when operating a server of operation target, using the above integrated graph 65.

FIG. 5 illustrates an example of procedure search. In the example of FIG. 5, the graph 65 illustrated in FIG. 4 is searched for a procedure. Then, as for a search condition, an initial condition 66 is set to the conditions of the condition ID “condition 11” and “condition 12”, and a target condition 67 is set to the condition of the condition ID “condition 31”. The initial condition 66 is a condition satisfied by a server of operation target. The target condition 67 is a condition that the server of operation target is expected to satisfy after operation. That is, the graph 65 is searched for a work procedure that makes the server of operation target to satisfy the target condition 67.

When a search condition is input, the graph 65 is searched for a target condition. The graph 65 includes a condition (condition ID “condition 31”) corresponding to the target condition 67. Thereafter, it is determined whether to be able to trace back to the initial condition 66 on the graph 65, from the condition corresponding to the target condition 67. The graph 65 includes conditions (condition IDs “condition 11” and “condition 12”) corresponding to the initial condition 66. Then, the node of the condition corresponding to the initial condition and the node of the condition corresponding to the target condition 67 are connected via the nodes of the operation ID “operation 1”, the condition ID “condition 13”, and the operation ID “operation 3”. Thus, nodes and edges on the route are extracted as a result of the search, to generate a subgraph 68.

Note that the precondition of a specific operation in the subgraph 68 needs to be the initial condition or a postcondition of another operation that is executable before the specific operation. For example, when tracing back from the node of the condition ID “condition 31” on the graph 65, there is a route through the node of the operation ID “operation 4”, the node of the condition ID “condition 22”, the node of the operation ID “operation 2”, and the node of the condition ID “condition 12”. However, the condition ID “condition 21”, which is a precondition of the operation of the operation ID “operation 2” on this route is neither appropriate for an initial condition, nor for a postcondition of executable operation. Hence, the node of the condition ID “condition 21” is unable to be selected, and the route passing through this node is excluded from the target of search.

Although there is only one target condition in the example of FIG. 5 for simplicity of explanation, the management server 100 searches for a procedure for each target condition when there are a plurality of target conditions. Then, the management server 100 integrates a subgraph of each target condition, by combining same operations or conditions.

In a procedure searching unit 160, the generated subgraph 68 represents an operation procedure 69 of operations on the server of operation target. A procedure executing unit 170 generates a script on the basis of the subgraph 68. For example, the procedure executing unit 170 arranges the operations included in the extracted subgraph 68, in such a manner that an operation is executed earlier as the operation is closer to the initial condition. That is, when there is an operation C whose postcondition is a precondition B of a certain operation A, the procedure executing unit 170 arranges the operations in such a manner that the operation C is executed earlier. The method for arranging operations is, for example, topological sort.

In this way, a script in which operations are arranged is generated. In the example of FIG. 5, a script describing a procedure for executing the operation of the operation ID “operation 3” subsequently to the operation of the operation ID “operation 1” is generated.

As described above, the management server 100 divides the operation procedure of the work that has been performed in the past into operations, and generates an operation procedure reutilizing the divided operation procedure. That is, short procedures (operations) of small size are reutilized. Thereby, even when the server 100 is unable to find a case that matches a search condition from among a large collection of procedures, such as all work of the past, the server 100 generates an operation procedure that matches the search condition by combining individual operations. As a result, an operation procedure is generated more frequently, and the reutilization rate of the past procedures improves. Thus, working steps are reduced.

In the meantime, work for building and operating a system sometimes includes an editing operation, such as edit of a configuration file, as well as creation and adjustment of a file. This edit operation is executed using an editing software, such as an editor, for example. A manual operation by an operator to the editing software is not included in work logs. Hence, operator's manual file-editing operations are unable to be reutilized for automatically generating a work procedure that is processed in a server of operation target, using work logs only.

For example, it is assumed that there is an operation “edit aaa.conf” in a work log. Here, “edit” is an instruction for activating an editor. “aaa.conf” is a file name of edit target. How to edit a file (how a file has been edited) is unable to be known from the character string of this operation. That is, how to edit a file depends on the input to the editor by an operator, and the input to the editor is not included in the work log. Hence, how to edit a file is unable to be determined. Note that, even if the input to the editor is acquired, what edit is executed in response to the input depends on the editor. There are a large number of software editors, and therefore it is difficult to determine how to edit a file by analyzing their behavior in response to an input, with respect to all editors.

As described above, when a work procedure includes an edit operation of a file by software, such as an editor, a work log does not include information of what edit operation is performed, and therefore the performed edit operation is unable to be reutilized.

Note that, when an edit operation is performed, what is important is how a file is edited, and editing software, such as an editor, is just edit means. When a performed procedure is analyzed on the basis of its operation logs only, an operation “edit aaa.conf” using a certain editor and an operation “edit2 aaa.conf” using another editor are recognized as different operations. In reality, there are wide variety of editors. Thus, if each editor type were recognized as different operation, input-output files for editors would become preconditions and postconditions redundantly, which results in a graph that is too large. Also, unnecessary dependency, such as a procedure for installing an editor, can be generated. As a result, a graph becomes larger, prolonging the processing time of procedure search and increasing the memory capacity used. Also, procedures including unnecessary operations are searched for, causing the search process to be prolonged.

Thus, in the second embodiment, how a file has been changed manually is clarified to automatically create an operation procedure including manual file editing operation, and how to edit a file is rewritten into a description of automatic operation. In the following, a rewrite process for clarifying how a file is changed manually is referred to as “normalization”.

The normalization process is roughly divided into below three processes.

1. Process for Detecting File Editing Operation

The servers 41 to 44 detect the operator's manual file-editing operation without “a dictionary indicating what operation an editor executes”. For example, the servers 41 to 44 monitor an input from an operator, during a certain operation from its start to end. Then, the servers 41 to 44 determine that an operation is “edit by an editor”, when there are one or more inputs from an operator.

2. Process for Creating Difference Between File Before Edit and File after Edit

The servers 41 to 44 create a difference between an edit target file before edit and the edit target file after edit. For example, the servers 41 to 44 acquire a difference between a file before edit and the file after edit, when detecting an operation of “edit by an editor” by detecting a process of edit operation. For example, the Linux (registered trademark) includes a “diff” command for acquiring difference information indicating a difference between files. This command is executed to acquire a difference. Note that a copy of the file before edit is created to acquire a difference. A method for acquiring a difference is, for example, two methods which are different from each other with respect to when to copy a file.

<Difference Acquiring Method 1>

The servers 41 to 44 create a copy of a file before edit (an example: aaa.conf.bak) before executing a write into an output file (an example: aaa.conf) during an operation, and acquire a difference between the copy and the file after edit (aaa.conf). For example, this is achieved by a below command.

diff -c aaa.conf.bak aaa.conf > aaa.conf.diff

<Difference Acquiring Method 2>

The servers 41 to 44 acquire copies of all files that the servers 41 to 44 read, and acquire differences with respect to all copy files when the operation ends, in the same way as described above. Note that the servers 41 to 44 discard files having no difference.

In the second embodiment, the difference acquiring method 1 is employed. Note that the difference acquiring method 2 is employed in the third embodiment described later.

3. Normalization Process of Log

The management server 100 normalizes an edit operation log to generate an operation log that automates an edit operation on the basis of a difference during edit. For example, the management server 100 replaces an operation and an input-output file in an edit operation log, with the following.

<Input File>

The management server 100 sets an original file before edit, a difference, and a command execution program for generating a file after edit from the original file and the difference, as input files. As for the command execution program, a program module for executing commands in the OS is set as the input file, when the command execution program is able to be executed with internal commands of the OS. For example, next input files are set.

aaa.conf (original file), aaa.conf.diff (difference), patch (command)

<Output File>

The management server 100 sets the file after edit as an output file. For example, a next output file is set.

aaa.conf (file after edit)

<Operation>

The management server 100 sets an operation character string including a command name and a difference file name, as an operation. For example, a next operation is set.

patch aaa.conf aaa.conf.diff

Such replacement is performed on logs in which operations and input-output files are recorded, as well as graphs extracted from those logs. In the second embodiment, the management server 100 rewrites the description of logs. Note that an example that replaces graphs is illustrated in the third embodiment described later.

The above is the outline of process for normalizing the logs. Note that the process for detecting file editing operation is performed to make processes efficient. When it is unable to be determined whether a certain operation is a manual edit operation, the difference of file is acquired for all operations. If the difference information of the utilized file is acquired for all operations, the amount of processing the difference information and the amount of memory for storing the difference information increase, and the size of the graph becomes large. If the graph is large, the search time and the memory amount increase. Thus, in the second embodiment, the difference information of file is acquired for a manual file edit only, in order to make the process efficient.

A manual file edit is identified, for example, by using a dictionary (dictionary of editors) indicating what operation (command) is executed by an editor. Specifically, the servers 41 to 44 have a dictionary of activation commands of editors in the form of [“edit”, “edit2”, . . . ], and assume a character string of operation including any activation command, as a manual operation. In this case, the operation “edit aaa.conf” is determined to be an operation including a manual operation, and the operation “service tomcat start” is determined to be an operation not including a manual operation. Note that this method does not effective when an unknown editor that is not registered in the dictionary is used to edit a file.

Thus, the servers 41 to 44 monitor an input from an operator, during a certain operation from its start to end. Then, the servers 41 to 44 assume the operation as “edit by an editor”, when there are one or more inputs from an operator. Thereby, the operator's manual file-editing operation is detected without “a dictionary indicating what operation an editor executes” in advance.

Next, functions of each server 41 to 44 and of the management server 100 for generating an operation procedure reutilizing work including an edit operation will be described.

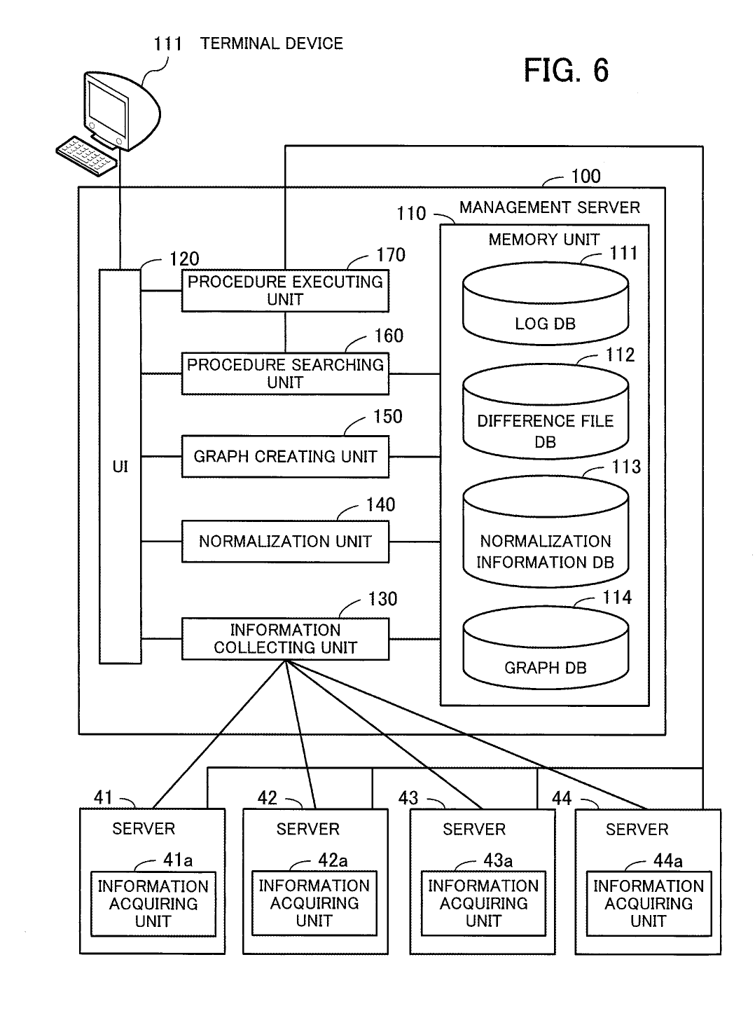

FIG. 6 is a block diagram of the function of each device. The servers 41 to 44 of management target include information acquiring units 41a, 42a, 43a, and 44a, respectively. The information acquiring units 41a, 42a, 43a, and 44a acquire a work log and difference information of a file edited by an edit operation. The information acquiring units 41a, 42a, 43a, and 44a transmit the acquired difference information to the management server 100.

The management server 100 includes a memory unit 110, an user interface (UI) 120, an a information collecting unit 130, a normalization unit 140, a graph creating unit 150, a procedure searching unit 160, and a procedure executing unit 170.

The memory unit 110 stores a log database 111, a difference file database 112, a normalization information database 113, and a graph database 114. For example, a part of storage region of the memory 102 or the HDD 103 is used as the memory unit 110. The log database 111 stores operation logs that are collected from the servers 41 to 44. The difference file database 112 stores difference files that are collected from the servers 41 to 44. The difference file is a file including difference information of a file edited by an edit operation. The normalization information database 113 stores information relevant to edit operations of normalization target, among the operations recorded in the operation logs. The graph database 114 stores the generated graphs.

The user interface 120 accepts an input from an operator. For example, the user interface 120 accepts an input of search condition into the server of operation target, to search for an operation procedure. When a search condition is input, the user interface 120 transmits the search condition to the procedure searching unit 160. Also, the user interface 120 displays on the monitor 21 the result of the process that is executed in response to the input from the operator.

The information collecting unit 130 collects information, such as operation logs, difference files, and normalization information, from the servers 41 to 44. The information collecting unit 130 stores the collected information in the memory unit 110. For example, the information collecting unit 130 stores operation logs in the operation log database 111, and difference files in the difference file database 112, and the normalization information in the normalization information database 113.

The normalization unit 140 normalizes the logs relevant to file edit operation, among the operation logs stored in the log database 111, in such a manner to clarify how to operate a file. The normalization unit 140 updates the log database 111 with the normalized operations.

The graph creating unit 150 creates a graph on the basis of the log database 111, after normalizing the edit operations. The graph creation method is as illustrated in FIG. 4. The graph creating unit 150 stores the created graph in the graph database 114.

The procedure searching unit 160 searches the created graph for a procedure. For example, the procedure searching unit 160 acquires a search condition from the user interface 120, and searches for a procedure that satisfies the acquired search condition, with reference to the graphs in the graph database 114. The procedure search method is as illustrated in FIG. 5. The procedure searching unit 160 transmits the searched procedure to the procedure executing unit 170.

The procedure executing unit 170 executes an operation to the server of operation target in accordance with the acquired procedure.

Note that the lines that connect between the elements in FIG. 6 illustrate a part of communication routes, and communication routes other than the depicted communication routes can also be used. Also, the function of each element illustrated in FIG. 6 may be configured by causing a computer to execute a program module corresponding to the element, for example.

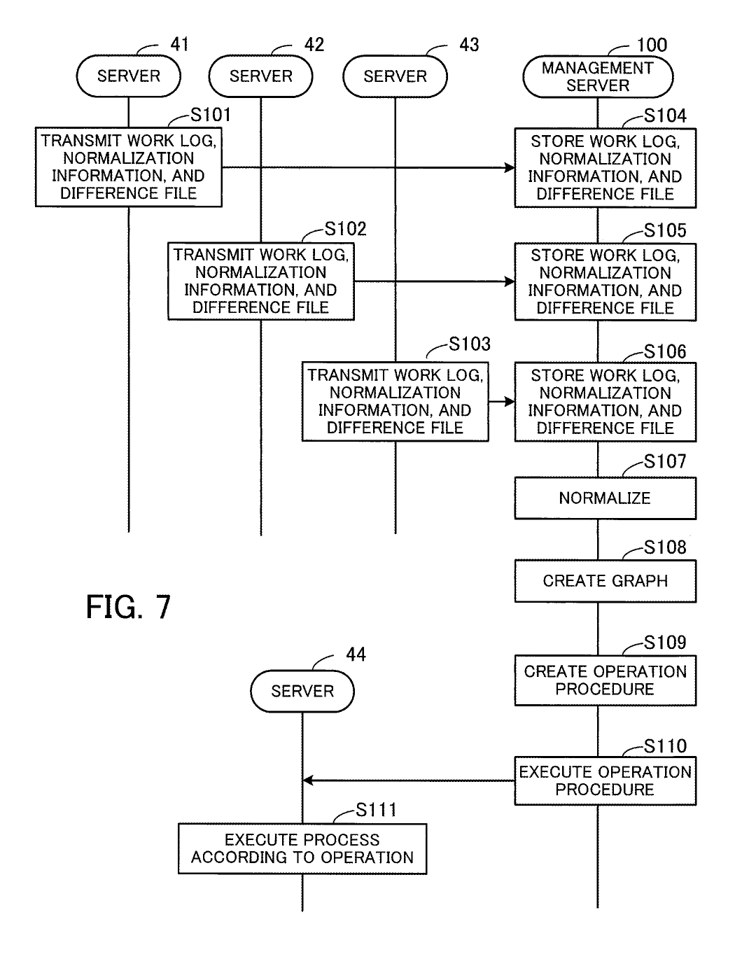

FIG. 7 is a sequence diagram illustrating an example of a process sequence for reutilizing a work procedure of the second embodiment. In the example of FIG. 7, a work procedure of work performed on the server 44 is created, utilizing operations performed on the servers 41 to 44, and the work is performed automatically on the server 44.

When work is performed on each of the servers 41 to 43, the information acquiring units 41a, 42a, and 43a each create normalization information and a difference file and transmit a work log, normalization information, and a difference file to the management server (steps S101 to S103). In the management server 100, the information collecting unit 130 receives the work log, the normalization information, and the difference file, and stores them in the memory unit 110 (steps S104 to S106).

The normalization unit 140 of the management server 100 normalizes information of how to operate to edit a file, on the basis of the normalization information (step S107). Thereafter, the graph creating unit 150 creates graphs of respective operations indicated in the work logs, and integrates those graphs, as illustrated in FIG. 4 (step S108). Then, the graph creating unit 150 stores the created graphs in the graph database 114.

The procedure searching unit 160 of the management server 100 creates a work procedure that is executable in the server 44, on the basis of the graphs stored in the graph database 114, as illustrated in FIG. 5 (step S109). In this process, the work procedure is created, assuming that the difference file is in the server 44. Then, the procedure executing unit 170 of the management server 100 transmits the difference file to the server 44, and performs a remote operation to the server 44 in accordance with the created work procedure (step S110). In the server 44, a process is executed according to an operation from the management server 100 (step S111).

With the above procedure, work is automatically performed on the server 44, reutilizing operations in work procedures that have been performed on the servers 41 to 43. Note that when work is performed in the server 44, information corresponding to the work, such as a work log, is transmitted to the management server 100. Also, when work is to be performed in the servers 41 to 43, the management server 100 may generate a work procedure on the basis of work logs and perform the work on the servers 41 to 43 by remote operation.

Next, a process for transmitting a work log, normalization information, and a difference file in the server 41 will be described in detail. In the system illustrated in FIG. 6, the operator accesses the server 41 of operation target via the management server 100. In this case, the server 41 monitors an operation by the operator, a file access in the operator's operation, and the like.

As means of monitoring, there is a tool called “strace” of the Linux (registered trademark), for example. With the strace, a system call can be monitored. Thus, in the server of operation target, a system call, such as open, read, and write, of an operation process is monitored to acquire logs relevant to file operation, standard input and output, and error output. As a range of one operation, a range from an output of a prompt character string to the next output of a prompt character string is detected by monitoring write system calls, for example.

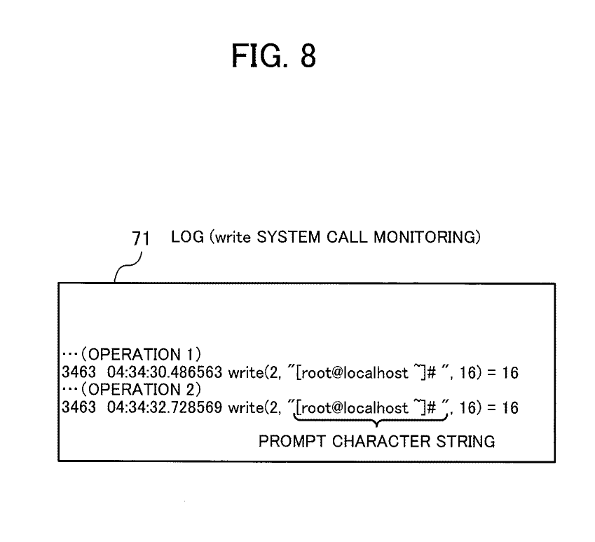

FIG. 8 illustrates a log output example including a prompt character string. The log 71 includes a process ID (PID), a time, a system call execution process, for example. The PID is an identifier of a process of operation. The time is a time at which a system call is detected. Then, during each operation, information including a character string of a prompt is output. In the example of FIG. 8, “3463” in the log after “operation 1” is the PID, and “04:34:30.486563” is the time, and the subsequent character string is the process of the system call. The log 71 illustrated in FIG. 8 is the log acquired by monitoring a write system call. “[root@localhost ˜]#” in the system call execution process of the log 71 is the character string of a prompt. A start of a new operation is determined by detecting emergence of the character string of a prompt.

In an operation for editing a file, there is an input from an operator, during the operation from its start to end. Thus, an input by an operator is monitored during each operation. An input by an operator is acquired by monitoring a sendmsg system call, for example.

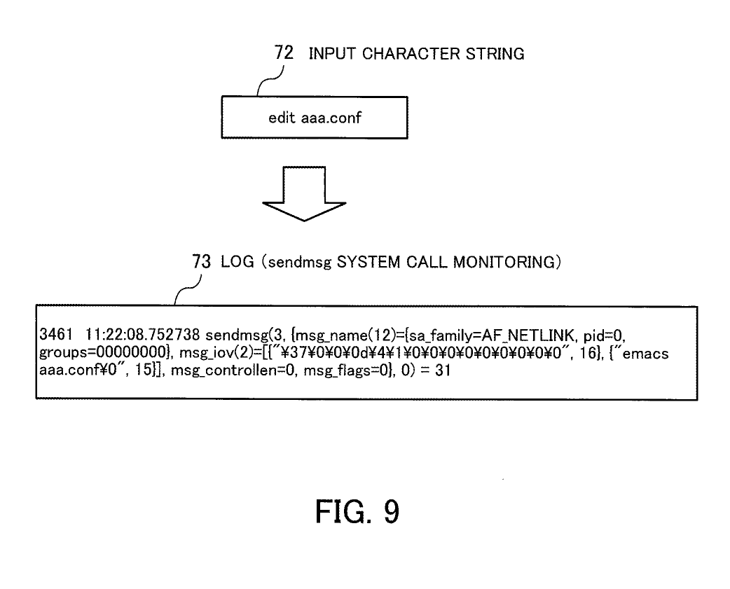

FIG. 9 illustrates an example of a log in response to an input of an operator. For example, it is assumed that an operator inputs an input character string 72, which is “edit aaa.conf”, at a prompt. In this case, for example, the server 41 acquires a log 73, which is “3461 11:22:08.752738 sendmsg(3, {msg_name(12)=fsa_family=AF_NETLINK, pid=0, groups=00000000}, msg_iov(2)=[{“¥37¥0¥0¥0d¥4¥1¥0¥0¥0¥0¥0¥0¥0¥0¥0”, 16}, {“emacs aaa.conf¥0”, 15}], msg_controllen=0, msg_flags=0}, 0)=31”.

It is possible that the operation character string indicated in the log 73 is rewritten by the normalization. Thus, the server 41 temporarily records the line of the sendmsg system call as the “operation line” in the memory, for example. Then, the server 41 saves the line indicated in the log 73 in the log database 111, when the line is found to be an “input from an operator”.

During the operation, a file is input and output. The input file is a precondition for executing the operation. The output file is a postcondition for executing the operation. Information indicating an input-output file is acquired as a log, by monitoring an open system call during the operation, for example.

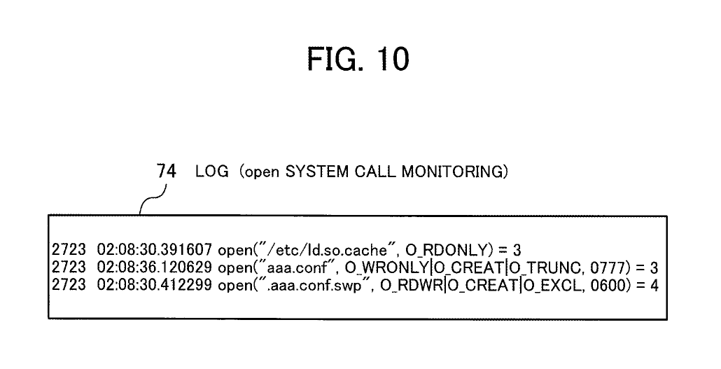

FIG. 10 illustrates an example of a log relevant to an input-output file. A log 74 is acquired by monitoring the open system call, and includes a character string “open” in the system call execution process. As illustrated in FIG. 10, the first line of the log 74 indicates that the file “/etc/ld.so.cache” is opened in the O_RDONLY mode. The second line indicates that the file “aaa.conf” is opened in the O_WRONLY|O_CREAT|O_TRUNC mode. The third line indicates that the file “.aaa.conf.swp” is opened in the O_RDWR|O_CREAT|O_EXCL mode.

It is possible that an input-output file in operation is replaced by normalization. Thus, the server temporarily records in the memory the log 74 indicating an input-output file, for example. Then, when the log is found to be an “input from an operator, the server 41 saves in the log database 111 the log indicating an input-output file”.

The meaning of the modes indicated in the log 74 is as describe below.
O_RDONLY: a file is opened for read only
O_WRONLY: a file is opened for write only
O_CREAT: a file is created when the file does not exist
O_TRUNC: a file is truncated to a length of 0, when the file already exists in the O_RDWR or O_WRONLY mode
O_RDWR: a file is opened for read and write
O_EXCL: try to open a file in an exclusive manner, when used in conjunction with O_CREAT; that is, an error occurs when a file already exists

An input-output file is classified according to which mode the input-output file is in, O_RDONLY, O_WRONLY, or O_RDWR, among the above modes. Classification is performed as in the following. If the mode includes O_RDONLY, the file of operation target is classified into input file. If the mode includes O_WRONLY, the file of operation target is classified into output file. If the mode includes O_RDWR, the file of operation target is classified into input file and output file.

According to this determination method, when finding an open system call, the server 41 adds an attribute of input, output, or both to each file, and records the file in the input-output file list.

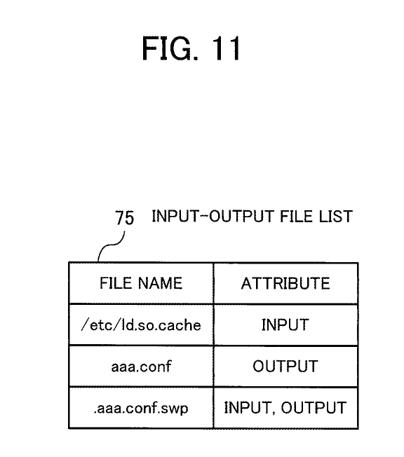

FIG. 11 illustrates an example of the input-output file list. In the input-output file list 75, attributes are set in association with file names of operation target files. The attribute of a file classified into input file is “input”. The attribute of a file classified into output file is “output”. The attribute of a file classified into input file and output file is “input, output”.

When a file edit operation is performed, there is an input from an input device that an operator operates during the operation. Thus, the server 41 determines whether there is an input from the input device that the operator operates during the operation. For example, the server 41 monitors whether there is an input from the input device that the operator operates, during each operation from its start to end. For example, the server 41 determines whether there is an input from the operator, by monitoring a read system call.

Note that, in the Linux (registered trademark), an input from an operator is passed to a process corresponding to operation, as a standard input. In this case, an input from an operator is accepted, either utilizing a virtual terminal (tty) or without utilizing the tty. In each case, an input from an operator can be observed as in the following.

When utilizing a tty, the server 41 monitors whether “/dev/tty” is opened and read. When the “/dev/tty” is read, the server 41 determines that there is an input from an operator. For example, the server 41 determines that there is an input from an operator, when the “/dev/tty” is opened in the O_RDWR or O_RDONLY mode, and the file descriptor=3 of the file is read.

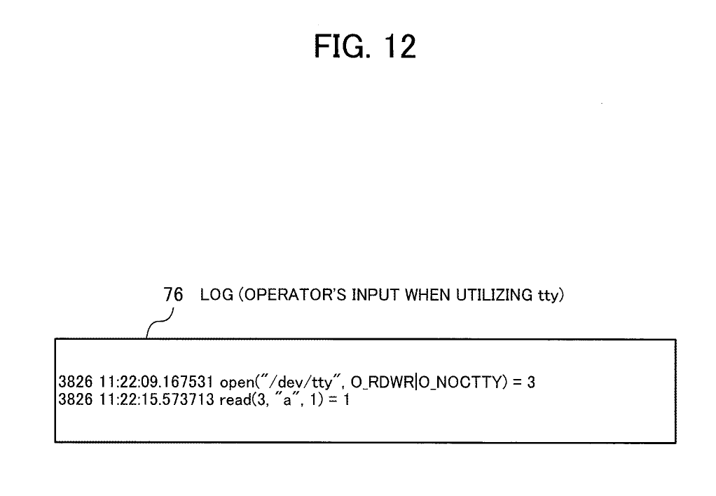

FIG. 12 illustrates a log of a system call indicating an input of an operator when utilizing a tty. In the log 76 of a system call indicating an input of an operator when utilizing a tty, the first line indicates that the file corresponding to the tty is opened, and the second line indicates that the character “a” is read from the file. Upon detecting a system call during a file operation, as in the log 76, the server 41 determines that there is an input from the operator to the file.

In contrast, when a tty is not utilized, “/dev/tty” is not opened in the O_RDWR or O_RDONLY mode in response to an input from the operator. Otherwise, “/dev/tty” is opened, but the opened file is not read. In this case, the server 41 can observe an input from an operator in the form of read(0, “input character” . . . ) by monitoring a read system call, for example.

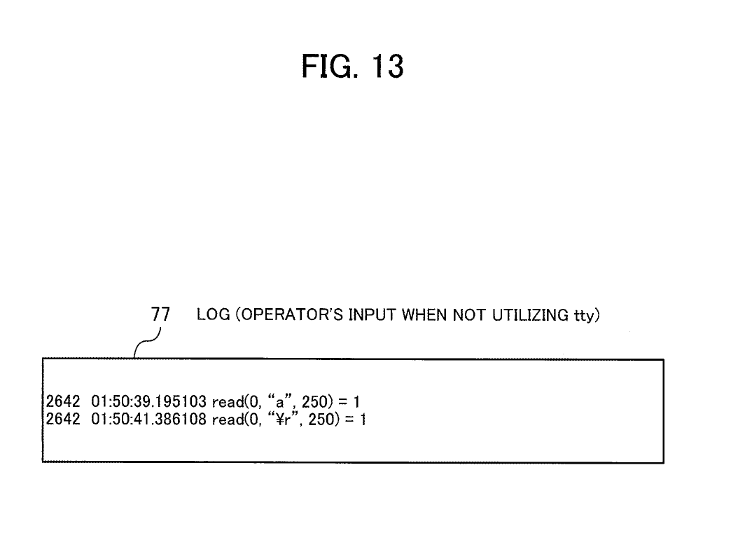

FIG. 13 illustrates a log of a system call indicating an input of an operator when not utilizing a tty. In the log 77 of a system call indicating an input of an operator when not utilizing a tty, “0” in read(0, “input character”, . . . ) indicates a file descriptor number. The file descriptor number “0” indicates a standard input. Also, the subsequent character string “a” is an input character string, and “1” at the end of the line indicates the length of the character string. Thus, the first line of the log 77 indicates that the character “a” is input, and the second line indicates that the ENTER key is pressed.

Note that the standard input obtained by read(0, . . . ) can be not only an input from an operator, but also an input of file content by redirection. Thus, the server 41 determines whether or not the input is an “input from an operator”. For example, an input is determined as in the following.

When there is an input from an operator, an input character string is usually fed back (echoed back) to a terminal device. Without echo back, the operator is unable to check whether the input is correct. Thus, the server 41 monitors an echo back. For example, if the character string obtained by a read system call of standard input is output by a write system call for standard output shortly thereafter (by the next read of standard input), the server 41 determines a “presence of input from operator”.

Thereby, a file edit operation is determined by a more widely applicable method than a method using a dictionary of editor names that is prepared in advance. When determining that there is an input from an operator during an operation, the server 41 records in the memory the input from the operator into the file that is currently operated.

When there is an input from an operator, the server 41 creates a copy of the file to acquire information of how to edit the file, i.e., a difference between the file before edit and the file after edit. A method for copying a file for acquiring a difference between the file before edit and the file after edit is, for example, the following two methods.
A first copy method in which a write into a file is monitored, and a system call is hooked when a write is executed, and a copy of the file is created.
A second copy method in which a file is copied each time the file is opened for write in an operation.

In the second embodiment, the first copy method is employed. Note that the second copy method is employed in the third embodiment described later.

The server 41, which has created a copy of a file, creates a difference file indicating the difference, by comparing the copy file and the file after operation after the file operation ends.

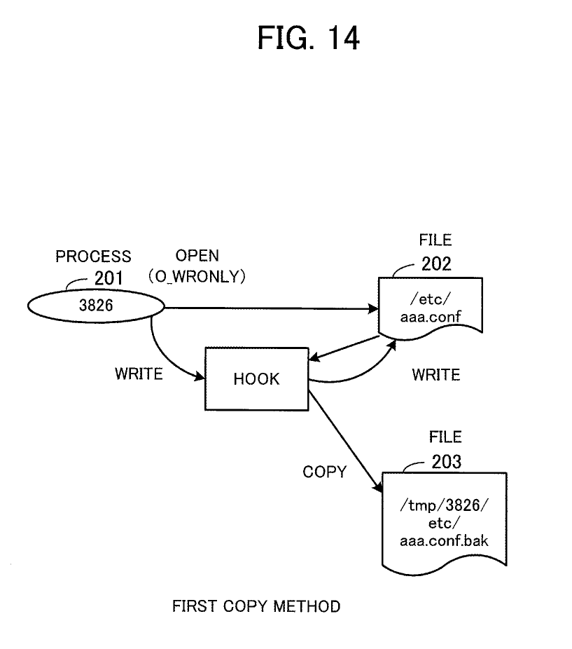

FIG. 14 illustrates an example of a method for copying a file. If a process 201 opens a file 202 in a mode in which the file 202 has a possibility of being written, the file 202 becomes a monitoring target. Then, when a write system call is issued to cause the process 201 to execute a write into the file, the system call is hooked, and a copy of the file 202 is generated. The file 203 generated by the copy is stored in the HDD, for example. Thereafter, a write is executed to the file 202.

For example, when an editor opens a file, the server 41 monitors an open system call and, if the opened file has a possibility of being written, adds the file to the monitoring file list. For example, if the open system call includes the O_WRONLY or O_RDWR mode, the opened file has a possibility of being written.

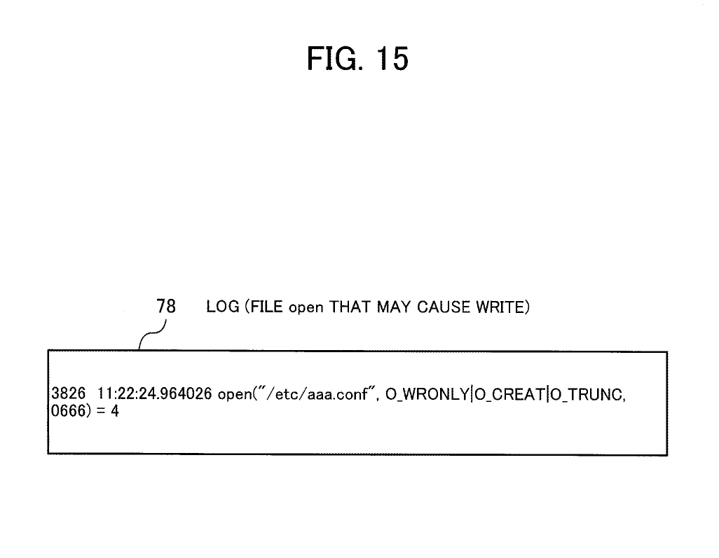

FIG. 15 illustrates an example of a log of a system call indicating a file open that may cause a write. A log 78 illustrated in FIG. 15 opens a file in the O_WRONLY mode. Thus, it is possible that a write is executed. If the file open may cause a write, the server registers the file in the monitoring file list, to make it a monitoring target of write.

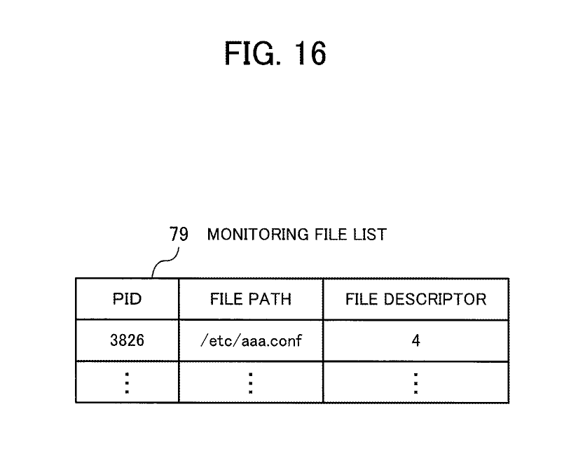

FIG. 16 illustrates an example of the monitoring file list. In the monitoring file list 79, file paths and file descriptors of files of monitoring target are set in association with PIDs. Note that each file path includes a position in a file directory structure and a file name.

The server 41 monitors a write into the files registered in the file list of monitoring target. For example, when an editor executes a write into a file, a write system call is issued internally in the server 41. The server 41 hooks the write system call. The server 41 records the log of the write system call, after hooking it.

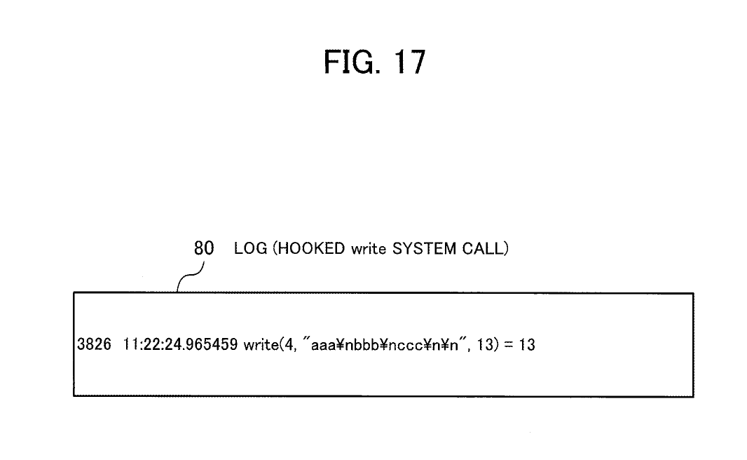

FIG. 17 illustrates an example of a log of a write system call. For example, if the file descriptor of the write system call in the log 80 is registered in the monitoring file list, the system call is hooked before its log 80 is recorded. The system call is hooked in the kernel module, for example. Upon hooking the write system call, the server 41 executes the following process, for example.

If the monitoring file list 79 includes a corresponding entry, a copy of a file is created. For example, the server 41 executes the following command.

cp <file path of monitoring file list><directory at which copy is put><PID><file path of monitoring file list>.bak

When the directory at which a copy is put is “/tmp”, a command “cp/etc/aaa.conf/tmp/3826/etc/aaa.conf.bak” is executed, for example. The server 41 records the information and the position of the copy file in the memory as copy file information.

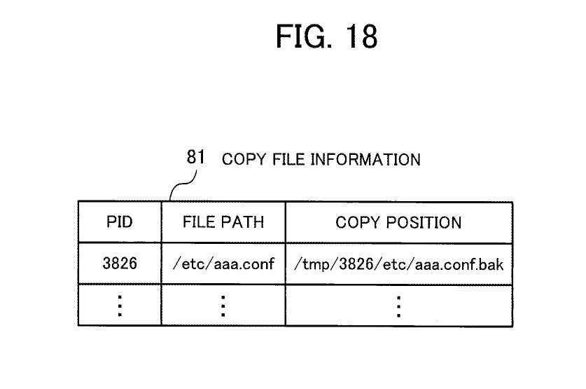

FIG. 18 illustrates an example of the copy file information. In the copy file information 81, file paths of copy master files and file paths (copy positions) of copy files are set in association with PIDs of processes that are in operation.

In the system-call hooking process, the server calls the original write system call at the end, regardless of presence or absence of a corresponding entry in the monitoring file list 79. Also, the server 41 monitors a close system call and, if a file of monitoring target is closed, deletes an entry having the same value of file descriptor as the closed file, from the monitoring file list 79.

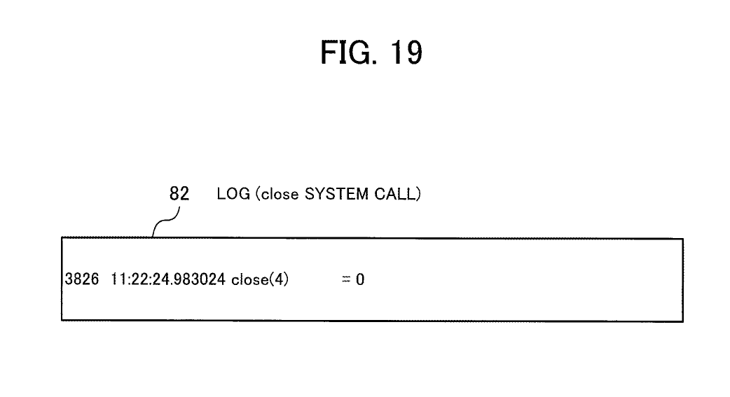

FIG. 19 illustrates an example of a log of a close system call. As illustrated in the log 82 of the close system call, the close system call indicates a file descriptor of a closed file. Thus, the server 41 searches the monitoring file list 79 for the value of the file descriptor indicated in the close system call. When there is a corresponding entry, the server 41 deletes the entry from the monitoring file list 79.

Also, the server 41 discards the monitoring file list 79, when one operation ends. In this way, when a file is written, a copy of the file before edit is created. In the first copy method, a file is copied before a write is executed, at a time point when the write into a file is generated, and thereby the process is made efficient without executing an unnecessary file copy.

A copy of a file before edit operation is created, in order to compare the file before edit operation and the file after edit operation, and determine their difference. Then, a difference file indicating the difference is created.

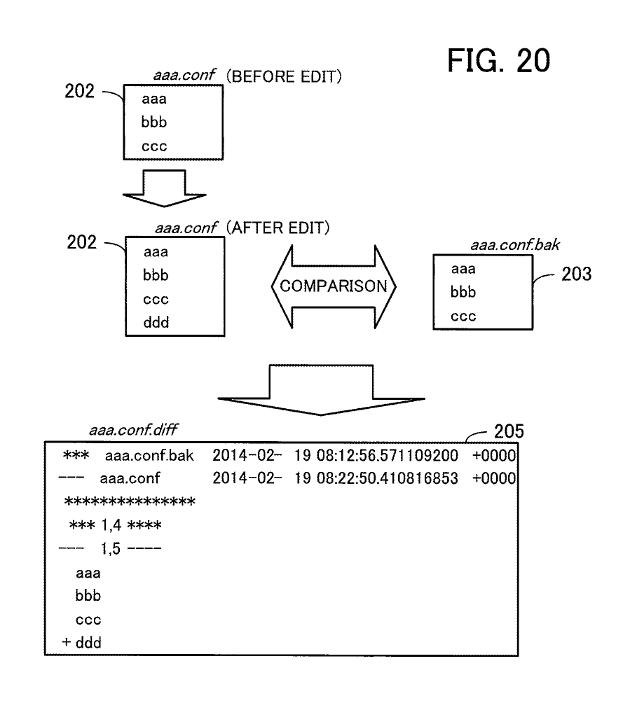

FIG. 20 illustrates an example of creation of a difference file. When operations end, and there has been an input from an operator during the operations, the server 41 acquires a difference between a copy file 203 and a master file 202. For example, the server 41 acquires a file path and a copy position for each entry of copy file information 81. Thereafter, the server 41 executes the following command.

diff -c <copy position of copy file information> <file path of copy file information> > <identifier of difference file>.diff

The command is as below, when the copy position of the copy file information is “/tmp/3826/etc/aaa.conf.bak”, and the file path of the copy file information is “/etc/aaa.conf”, and the identifier of a difference file 205 is “aaa.conf”.

diff -c /tmp/3826/etc/aaa.conf.bak /etc/aaa.conf > aaa.conf.diff

Thereby, the difference file 205 is created as in FIG. 20. Note that the file identifier of the difference file 205 is decided in accordance with a predetermined rule, so that the difference file 205 is uniquely identified when stored in the difference file database 112. As a method for making the file name of the difference file 205 unique, a digest, such as “sha1”, is created from the character string of <copy position of copy file information>, and is set as <identifier of difference file>, for example. When a file name of a file path is “/tmp/3826/etc/aaa.conf.bak”, the identifier of the difference file 205 is created by the next command.

$ echo “/tmp/3826/etc/aaa.conf.bak” | sha1sum -t

As a result of this command, a value “ef149b1b55f8bbc797240862dccfa0b881016710” is obtained, for example. When this value is the identifier of the difference file 205, the file name of the difference file 205 is “ef149b1b55f8bbc797240862dccfa0b881016710.diff”. Note that, in the description of the second embodiment, the file name of the difference file 205 is “aaa.conf.diff” for simplicity of explanation.

In the created difference file 205, the content of the file after edit is included, for example. Then, in the difference file 205, the file content after edit is indicated with a symbol “+” in the lines that are added as a result of the edit. Also, the difference file 205 includes file names and update dates and times of the compared files 202 and 203, for example.

When there is a difference between the file before edit and the file after edit (for example, when the difference file size is not zero), it is determined that there has been an input from an operator during the file edit operation.

Upon creating the difference file, the server 41 transmits the difference file in addition to the work log up to then, to the management server 100. After transmitting the difference file, the server 41 discards the copy file information corresponding to the difference file, and deletes the file that is copied to create the difference file.

In this way, various types of information is transmitted to the management server 100 from the server 41. In the following, the procedure of creation and transmission of these information will be described in detail.

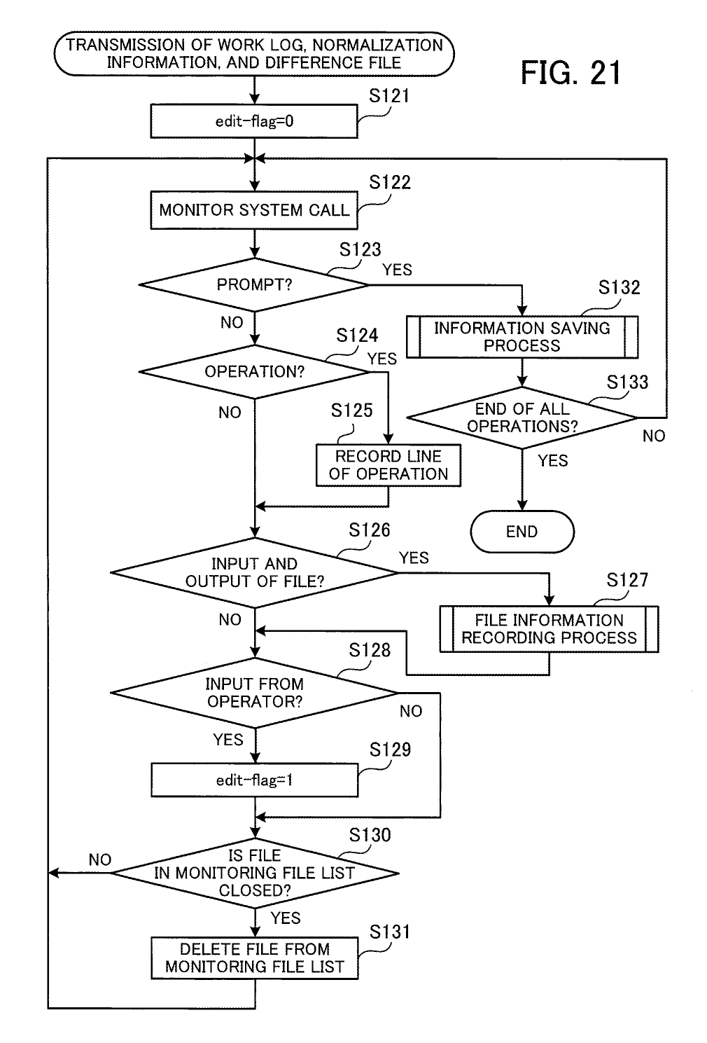

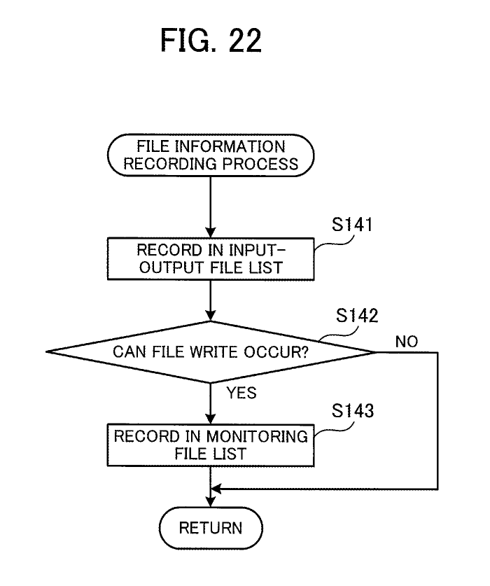

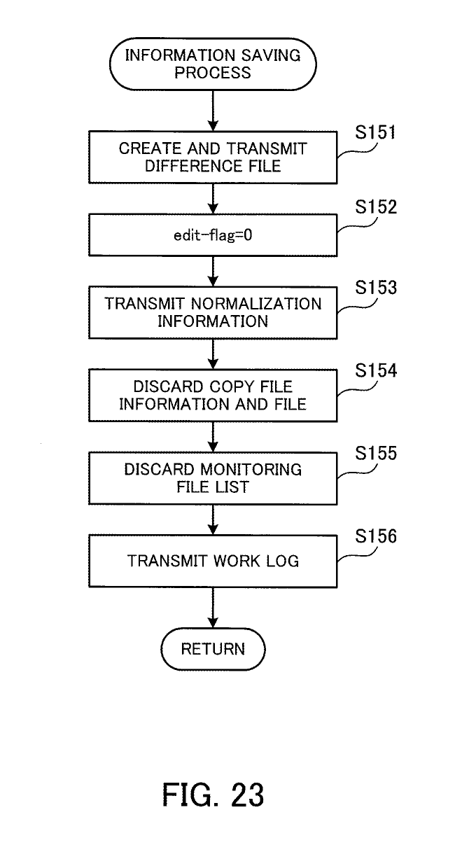

FIG. 21 is a flowchart illustrating an example of a procedure of a process for transmitting a work log, normalization information, and a difference file.

[Step S121] The server 41 sets zero in a variable “edit-flag”, which indicates presence or absence of an input from an operator.

[Step S122] The server 41 monitors a system call. The system call obtained by monitoring is recorded in the memory or the HDD as a log.

[Step S123] The server 41 determines whether or not the generated system call includes a character string indicating a prompt (refer to FIG. 8). If the generated system call includes a character string indicating a prompt, the server 41 determines that one operation has ended. In this case, the process proceeds to step S132. If the generated system call does not include a character string indicating a prompt, the process proceeds to step S124.

[Step S124] The server 41 determines whether or not the generated system call is a file edit operation (refer to FIG. 9). If the generated system call is a file edit operation, the process proceeds to step S125. If the generated system call is not a file edit operation, the process proceeds to step S126.

[Step S125] The server 41 records in the memory or the like the line of the log indicating the edit operation as “operation line”.

[Step S126] The server 41 determines whether or not the generated system call indicates an input-output process of a file (refer to FIG. 10). If the generated system call indicates an input-output process of a file, the process proceeds to step S127. If the generated system call does not indicate an input-output process of a file, the process proceeds to step S128.

[Step S127] The server 41 executes a file information recording process for recording file information into the input-output file list and the monitoring file list. The detail of this process will be described later (refer to FIG. 22).

[Step S128] The server 41 determines whether or not the generated system call indicates an input from an operator (refer to FIGS. 12 and 13). If the generated system call indicates an input from an operator, the process proceeds to step S129. If the generated system call does not indicate an input from an operator, the process proceeds to step S130.

[Step S129] The server 41 sets one in the variable “edit-flag”.

[Step S130] The server 41 determines whether or not a file is closed, and whether or not the closed file is registered in the monitoring file list. If a file registered in the monitoring file list is closed, the process proceeds to step S131. If a file registered in the monitoring file list is not closed, the process proceeds to step S122.

[Step S131] The server 41 deletes the closed file from the monitoring file list. Thereafter, the process proceeds to step S122.

[Step S132] If a system call including a character string of a prompt is generated, the server 41 executes an information saving process. The detail of this process will be described later (refer to FIG. 23).

[Step S133] The server 41 determines whether or not all operations have ended. For example, the server 41 determines that all operations have ended, when a communication connection for operations from the management server 100 to the server 41 is cut off. If all operations have ended, the process ends. If all operations have not ended, the process proceeds to step S122.

Next, the detail of the file information recording process (step S127) will be described.

FIG. 22 is a flowchart illustrating an example of the procedure of the file information recording process.

[Step S141] The server 41 records a file name and an attribute of a file of input-output target, in the input-output file list 75 (refer to FIG. 11).

[Step S142] The server 41 determines whether or not the file of input-output target is a file that has a possibility of being written (a file having an attribute of output). If a file that has a possibility of being written, the process proceeds to step S143. If not a file that has a possibility of being written, the list creation process ends.

[Step S143] The server 41 records information (a PID, a file path, and a file descriptor) of the file of input-output target, in the monitoring file list 79 (FIG. 16).

In this way, information relevant to the file of input-output target is recorded in the input-output file list 75 and the monitoring file list 79.

Next, the detail of the information saving process (step S132) will be described. FIG. 23 is a flowchart illustrating an example of the procedure of the information saving process.

[Step S151] The server 41 creates a difference file indicating a difference (refer to FIG. 20) between a master file and a file that is copied before editing the master file, on the basis of the copy file information 81 (refer to FIG. 18). Then, the server 41 transmits the difference file to the management server 100. Then, the management server 100 stores the difference file in the difference file database 112.

[Step S152] The server 41 sets zero in the variable “edit-flag”.

[Step S153] The server 41 generates normalization information and transmits it to the management server 100. Then, the management server 100 stores the normalization information in the normalization information database 113.

[Step S154] The server 41 discards the copy file information 81 and the copy file.

[Step S155] The server 41 discards the monitoring file list 79.

[Step S156] The server 41 transmits to the management server 100 the work logs that have not been transmitted. Then, the management server 100 stores the work logs in the work log database 111.

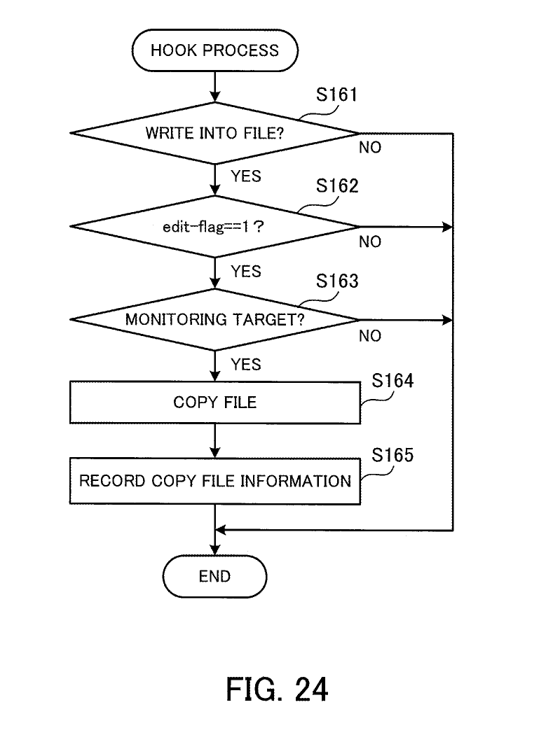

Next, the detail of the write hook process will be described. FIG. 24 is a flowchart illustrating an example of the procedure of the hook process. This process is executed each time a system call is detected, for example.

[Step S161] The server 41 determines whether or not the generated system call is a write into a file (refer to FIG. 17). If a write into a file, the process proceeds to step S162. If not a write into a file, the process ends.

[Step S162] The server 41 determines whether or not the value of the variable “edit-flag” is one. If the value is one, the process proceeds to step S163. If the value is not one, the process ends.

[Step S163] The server 41 determines whether or not a file of write target is registered in the monitoring file list 79 as a monitoring target. If the file is a monitoring target, the process proceeds to step S164. If the file is not a monitoring target, the process ends.

[Step S164] If the generated system call is a write into the file, and the value of the variable “edit-flag” is one, the server 41 creates a copy of the file of write target.

[Step S165] The server 41 records information of a copy master file and a copy file in association with each other, in the copy file information 81 (refer to FIG. 18).

After the hook process is completed, a write process of the system call is executed to achieve its original purpose. In this way, when a system call of a write into a file is generated, a file before edit is copied before a write is executed, by hooking the system call.

By the above process, a work log, a difference file, and normalization information are transmitted from the server 41 to the management server 100. The same process is executed in other servers 42 to 44. In the management server 100, the information collecting unit 130 receives the information transmitted from the servers to 44. Then, the information collecting unit 130 stores the received log in the log database 111, and the difference file in the difference file database 112, and the normalization information in the normalization information database 113.

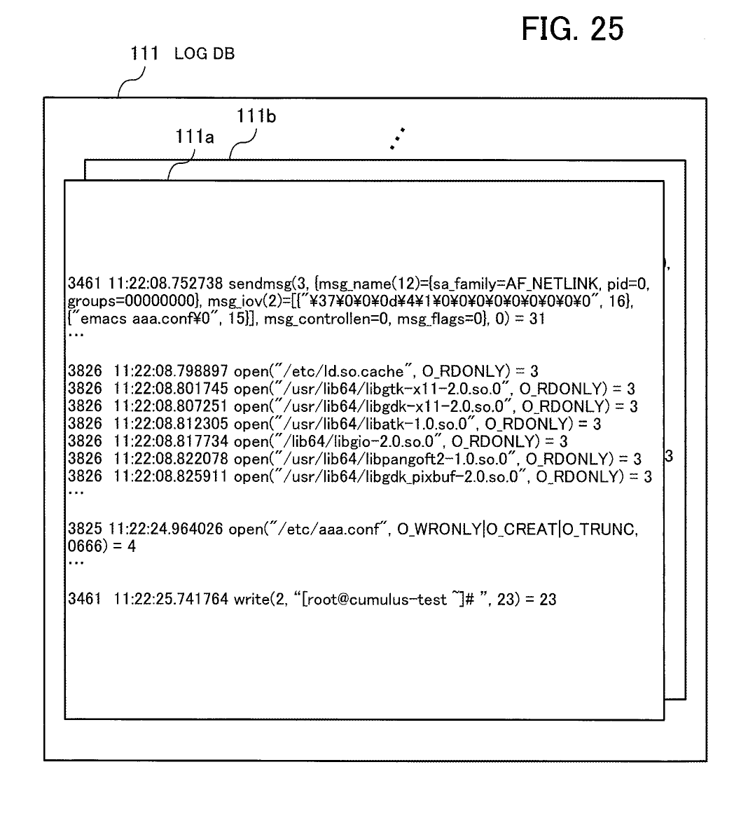

FIG. 25 illustrates an example of work logs in the log database. The log database 111 stores work logs 111a, 111b, . . . , which are received from each server 41.

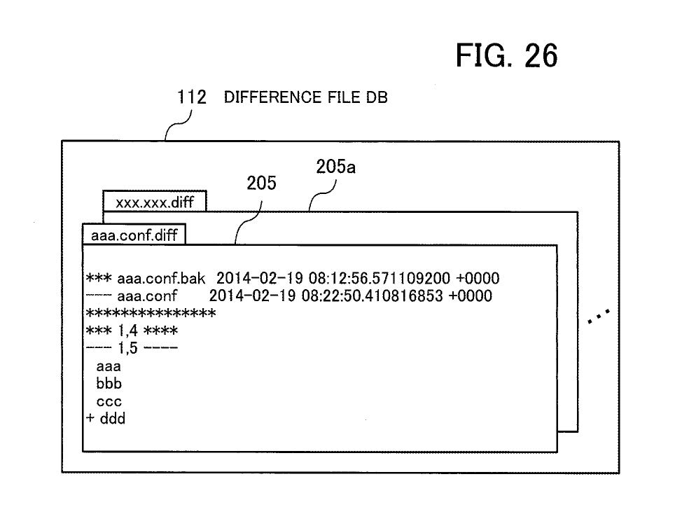

FIG. 26 illustrates an example of difference files in the difference file database. The difference file database 112 stores difference files 205, 205a, . . . , which are acquired from the server 41. Note that, when a server reutilizes a work procedure including an edit operation corresponding to a difference file, the difference file is distributed to the server. Upon receiving the difference file, the management server 100 registers the normalization information according to the difference, in the normalization information database 113.

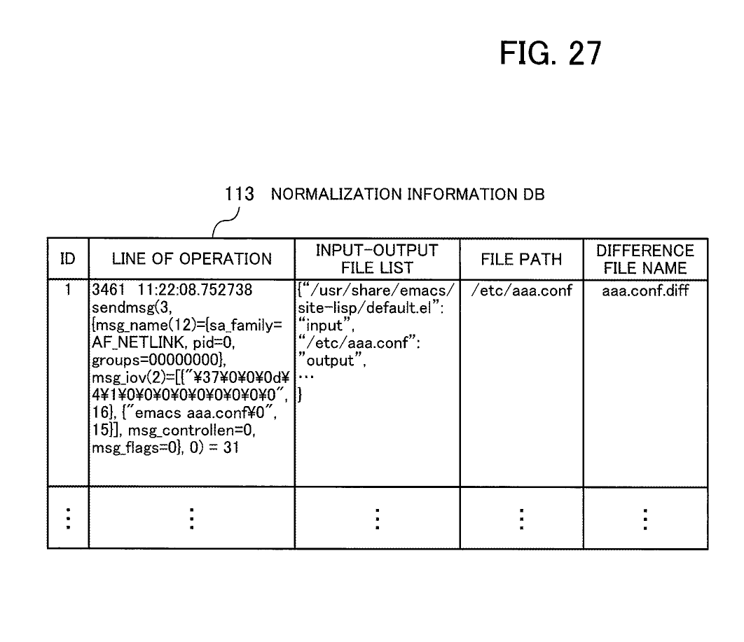

FIG. 27 illustrates an example of normalization information in the normalization information database. In the normalization information database 113, an ID, lines of the operation, an input-output file list, a file path, and a difference file name are set for each normalization information. An ID is an identifier of the normalization information. Lines of the operation are descriptions of lines in a work log indicating the operations in an edit work. An input-output file list is a list of an input file and an output file in an edit operation. A file path is a file path of a file edited by an edit operation. The difference file name is a file name of a difference file indicating a difference between a file before edit and a file after edit which is edited by an edit operation.

The normalization unit 140 of the management server 100 normalizes a log, using the normalization information and the difference file relevant to the edit operation. For example, the normalization unit 140 normalizes an edit operation log, each time the information of an individual edit operation is stored in the memory unit 110. Also, each time a series of work including an edit operation is completed, the edit operation log may be normalized. The normalization unit 140 replaces information of an operation and an output file, to normalize the operator's manual edit operation log into an automated operation log.

<Operation>

An edit operation is described in a log as an activation command of an editor and an input of an operator, for example. Thus, the normalization unit 140 replaces a description indicating, for example, an activation of an execution file of an editor and an input of an operator in a log, with a description indicating an execution of a process for integrating a difference indicated in a difference file into an original file. After replacement, the description is a normalized operation character string composed of a command name, a master file name, a difference file name, and the like, for example. When the command name is “patch”, and the master file name is “aaa.conf”, and the difference file name is “aaa.conf.diff”, the description indicating operation is replaced by the next description.

“patch aaa.conf aaa.conf.diff”

<Input File>

In an edit operation in an editor, an execution file of an editor, a configuration file of an editor, an edit target file, and the like are recorded in a log as input files. After normalization, the input files include a file before edit, a difference file, a command execution file for creating a file after edit from the difference file and the original file, and an input file group for this command. For example, the input files include aaa.conf (master file), aaa.conf.diff (difference file), patch (command execution file), and /etc/ld.so.cache, /lib64/libselinux.so.1, /lib64/libc.so.6, . . . (input file group for the command).

<Output File>

The output file is a file after edit. For example, when the master file is updated without changing its file name, the output file has the same file name “aaa.conf” as the master file.

Here, in order to reutilize edit operations, a graph generated based on logs accords with normalized logs. Hence, as a method for normalizing information of how to operate, there are a method that rewrites the stored log files to create a graph, and a method that rewrites a graph generated based on the logs. In the following, two rewrite methods will be described.

<Method of Directly Rewriting Log File>

As illustrated in FIG. 4, a graph of precondition, postcondition, and operation is created from logs. If edit operation logs are rewritten into a normalized form, a normalized graph is created from the logs.

The parts of a log which is to be rewritten are mainly a part of description relevant to operation and a part of description relevant to input-output file. For example, the part of description relevant to operation is a description of a sendmsg system call, and the part of description relevant to input-output file is a description of a file that is operated by an open system call.

For example, the normalization unit 140 selects an entry of the normalization information database 113. Thereafter, the normalization unit 140 extracts an operation line, a file path, and a difference file name, from the selected entry. The normalization unit 140 searches the log database 111 for a record that matches “operation line” of the selected entry. The normalization unit 140 decides a range of one operation including the matching record. The range of one operation is, for example, a range that is sandwiched between write system calls each including a prompt character string (refer to FIG. 8). Then, the normalization unit 140 rewrites the description relevant to operation and input-output file in the range of the operation.

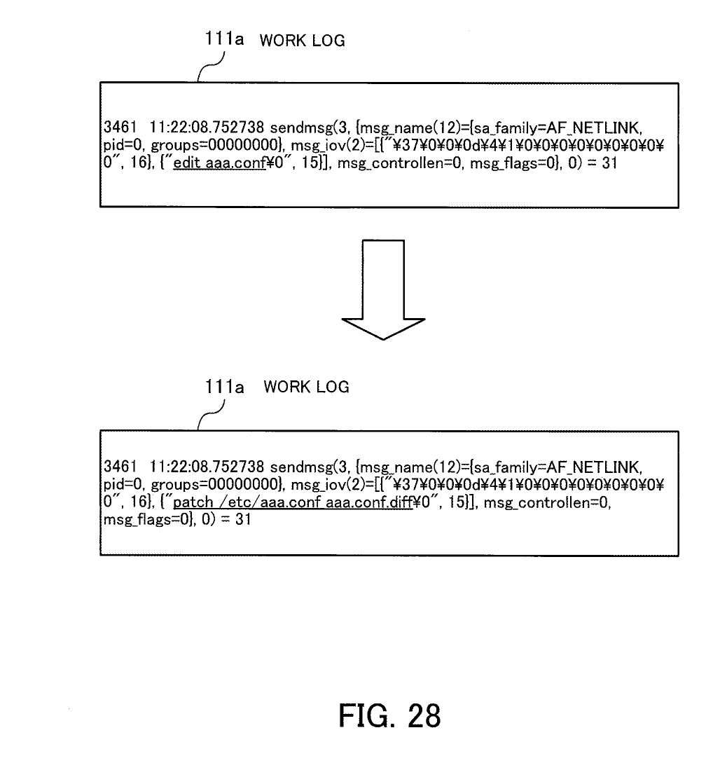

FIG. 28 illustrates an example of rewriting a description relevant to operation. Upon detecting a log that matches an operation line of normalization information from a work log 111a in the log database 111, the normalization unit 140 replaces the character string “emacs aaa.conf” of the operation of the log, with a normalized operation character string, such as “patch <file path> <difference file name>”. In the example of FIG. 28, the character string is replaced by “patch/etc/aaa.conf aaa.conf.diff”.

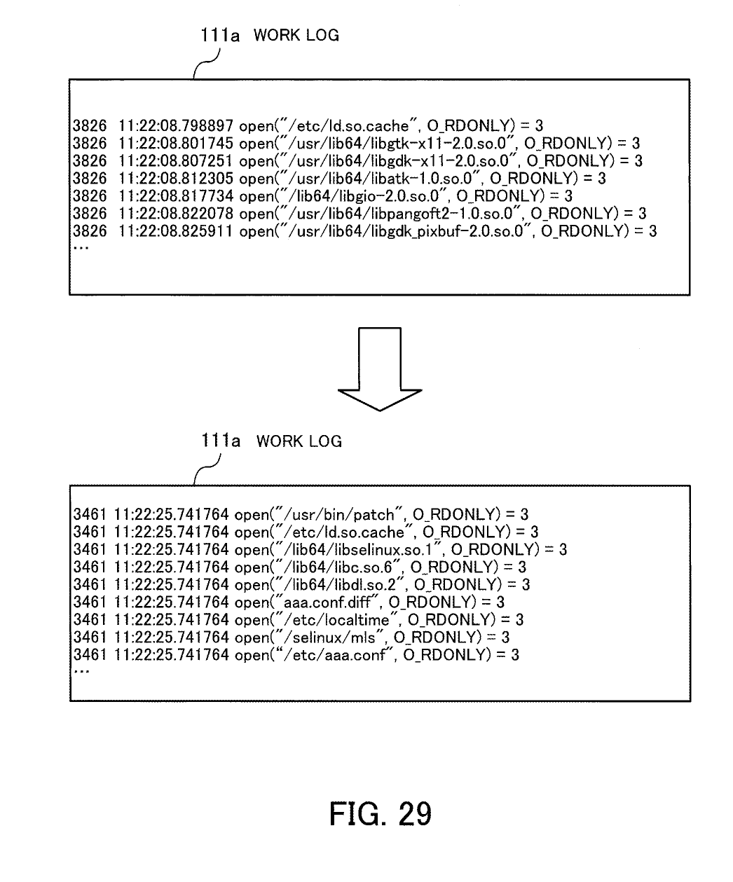

FIG. 29 illustrates an example of rewriting a description relevant to input file. The normalization unit 140 deletes all lines of open system calls of the log from a range of edit operation of the work log 111a. The following description of input file is inserted immediately before the end of the range of operation after deletion.

For example, the following description for opening a file of input target is added to each file of input target. Note that, when opening, the mode is a mode having an attribute of input (for example, O_RDONLY). The files of input target are a file before edit, a difference file, a command execution file for creating a file after edit from the difference file and the original file, and an input file group that is needed to execute this command. For example, the files of input target include aaa.conf (master file), aaa.conf.diff (difference file), /usr/bin/patch (command), and /etc/ld.so.cache, /lib64/libselinux.so.1, /lib64/libc.so.6, . . . (input file group for the command).

The form of an inserted description is ‘PID <time> open(“file name”, O_RDONLY)= 3’. For example, the description “3461 11:22:25.741764 open(“/etc/aaa.conf”, O_RDONLY) = 3” is inserted. In this case, the normalization unit 140 utilizes a PID of an operation for example, as the PID of the inserted description. In the example of FIG. 29, the PID is “3461”. Also, the normalization unit 140 utilizes a time in the last line of the range of the operation, as the time, for example. As for the work log 111a illustrated in FIG. 25, the time “11:22:25.741764” of the line ‘3461 11:22:25.741764 write(2, “[root@cumulus-test ˜]# ”, 23)=23’ is utilized as the inserted time of the line.

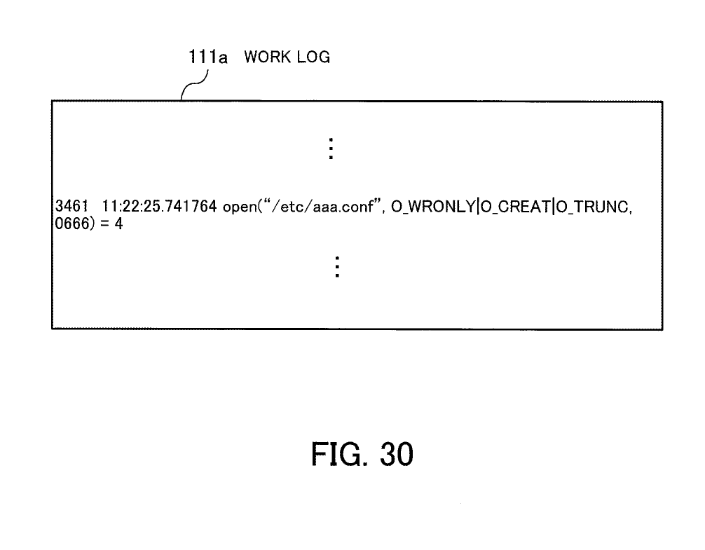

As for the output file, a description relevant to the output file is inserted, for example. FIG. 30 illustrates an example of inserting a description relevant to an output file. A description relevant to an output file is added to the range of the operation of rewrite target in the work log 111a. For example, a file after edit (i.e., output file) is “/etc/aaa.conf”, a description indicating a log of a system call for opening a file in the “O_WRONLY|O_CREAT|O_TRUNC” mode is inserted. In this case, the PID and the time are extracted from their source in the same way as the description inserted to an input file. In this way, the description relevant to edit operation in the work log 111a is normalized.

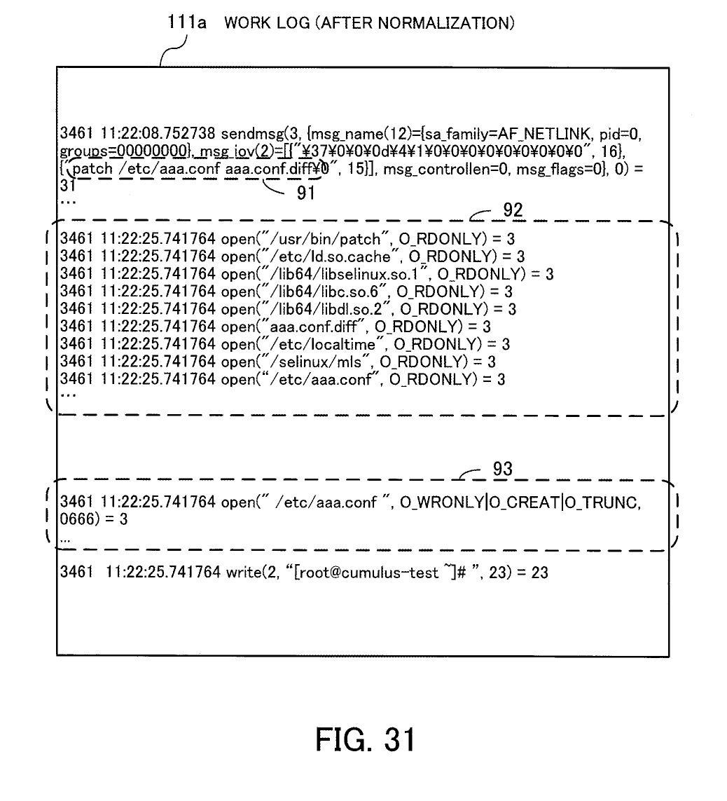

FIG. 31 illustrates an example of a work log after normalization. In the work log 111a, a description 91 relevant to operation and a description 92 relevant to input files are rewritten, and a description 93 relevant to output file is inserted, in order to normalize the work log 111a.

As described above, the work log is normalized, so that the description of the edit operation in response to the input of the operator is rewritten into an automatically executable description in the work log. The work including the edit operation is reproduced, by reproducing the work performed in each server 41, using the work log after the normalization.

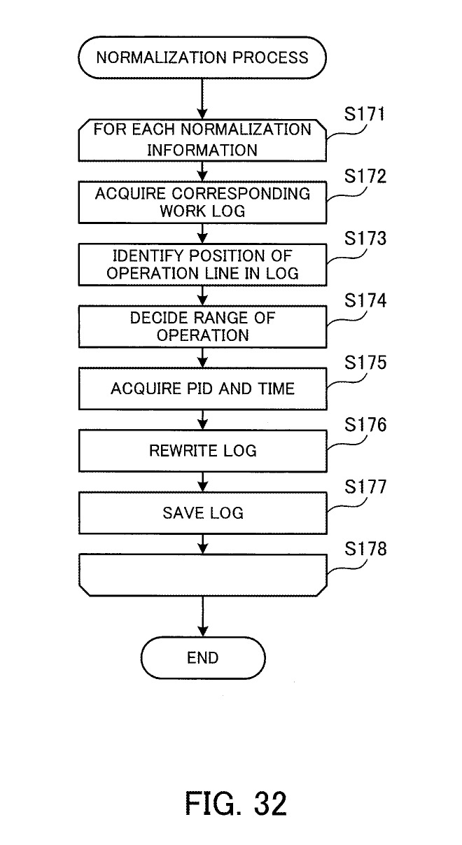

Next, a procedure of a normalization process will be described. FIG. 32 illustrates an example of the procedure of the normalization process.

[Step S171] The normalization unit 140 executes processes of steps S172 to S177, for each entry (normalization information) of the normalization information database 113.

[Step S172] The normalization unit 140 retrieves the work log corresponding to the normalization information from the log database 111.

[Step S173] The normalization unit 140 identifies the position, in the work log, of the operation line indicated in the normalization information.

[Step S174] The normalization unit 140 decides the range of operation.

[Step S175] The normalization unit 140 acquires a PID and a time from the last line of the range of the operation.

[Step S176] The normalization unit 140 rewrites the description of the log in the range of the operation.

[Step S177] The normalization unit 140 overwrites and saves the work log in the log database 111, after rewriting the log.

[Step S178] The normalization unit 140 ends the normalization process, when completing the processes of steps S172 to S177 with respect to all normalization information.

In this way, information of how to edit a file manually is clarified in the work log. As a result, the procedure becomes reutilizable, including the manual file editing operation. User's labor in building and operating the system is reduced, by reutilizing the edit operation.

Also, normalization into automated operation enables the same editing operations to be expressed in one operation, so as to make the size of a graph smaller, regardless of the edit method such as an editor in use. As a result, less processing time and resources are used.

### Third Embodiment

Next, the third embodiment will be described. In the third embodiment, normalization is performed by creating a graph of each operation and thereafter rewriting the graph. In the third embodiment, a system call is not hooked. Instead, when a file is opened in a mode in which the file has a possibility of being written (i.e., O_RDWR and O_WRONLY mode), its copy is created.

In the following, the third embodiment, particularly its different point from the second embodiment, will be described. Note that the system configuration of the third embodiment is same as the configuration of the second embodiment illustrated in FIGS. 2 and 3. Also, the function of the third embodiment is same as the elements of the second embodiment illustrated in FIG. 6.

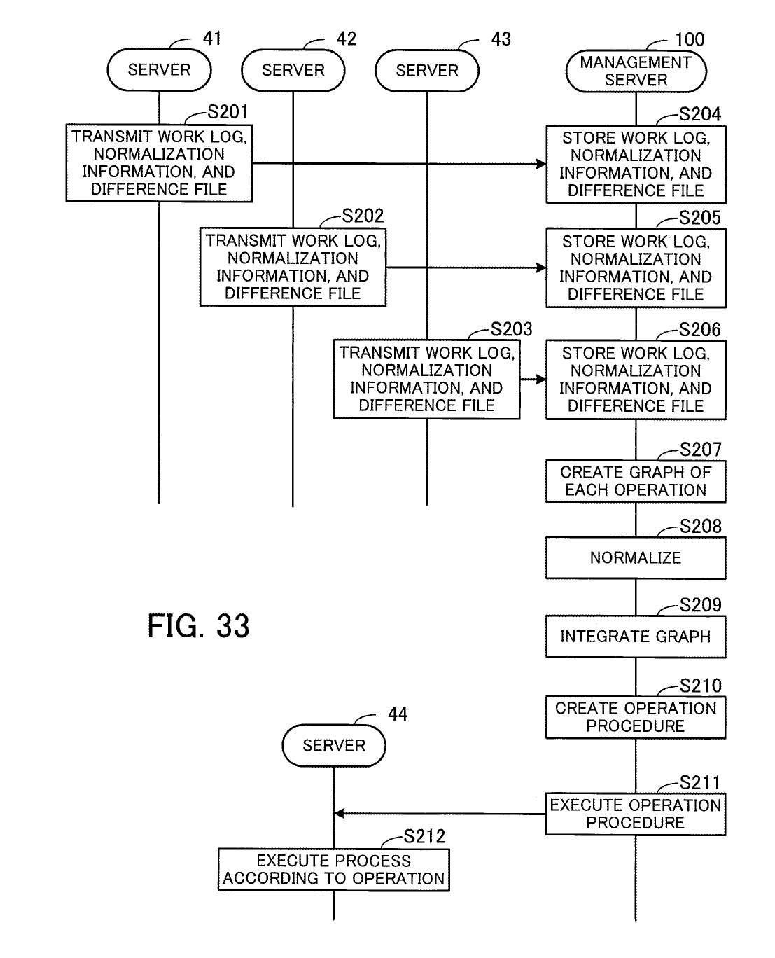

FIG. 33 is a flowchart illustrating an example of a process sequence for reutilizing a work procedure of the third embodiment.

When the work is performed on the servers 41 to 43, the information acquiring units 41a, 42a, and 43a create normalization information and a difference file, and transmits a work log, the normalization information, and the difference file, to the management server (steps S201 to S203). In the management server 100, the information collecting unit 130 receives the work log, the normalization information, and the difference file, and stores them in the memory unit 110 (steps S204 to S206).

The graph creating unit 150 of the management server 100 creates a graph of each operation indicated in the work log as illustrated in FIG. 4 (step S207). Thereafter, the normalization unit 140 normalizes the graph corresponding to the edit operation, in order to make the edit procedure reproducible (step S208). Thereafter, the normalization unit 140 integrates the graphs of individual operations (step S209). Then, the graph creating unit 150 stores a created graph in the graph database 114.

The procedure searching unit 160 of the management server 100 creates a work procedure that is executable in the server 44, on the basis of the graphs stored in the graph database 114, as illustrated in FIG. 5 (step S210). Then, the procedure executing unit 170 of the management server 100 remotely operates the server 44 in accordance with the created work procedure (step S211). In the server 44, a process is executed according to an operation from the management server 100 (step S212).

With the above procedure, work is automatically performed to the server 44, reutilizing operations in work procedures performed on the servers 41 to 43. Note that information, such as a work log, is also transmitted to the management server 100, in response to the work performed in the server 44. Also, when work is performed in the servers 41 to 43, the management server 100 may generate a work procedure on the basis of work logs and perform the work on the servers 41 to 43 by remote operation.

Next, a process for transmitting a work log, normalization information, and a difference file in the server 41 will be described in detail.

In the second embodiment, a write into a file is monitored, and a system call is hooked to create a copy of the file when a write is executed. In contrast, in the third embodiment, a file is copied, without hooking a system call. When a system call is not hooked, a write is not stopped, and therefore it is too late to copy a file after a write has started. Thus, the server 41 creates a copy of a file, each time a file is opened.

For example, the server 41 creates a copy of a file that has a possibility of being written (O_RDWR, O_WRONLY). The file that has a possibility of being written is a file having an output attribute in the input-output file list 75. Upon copying a file, the server 41 records the information and the position of the copy file in the memory, as copy file information.

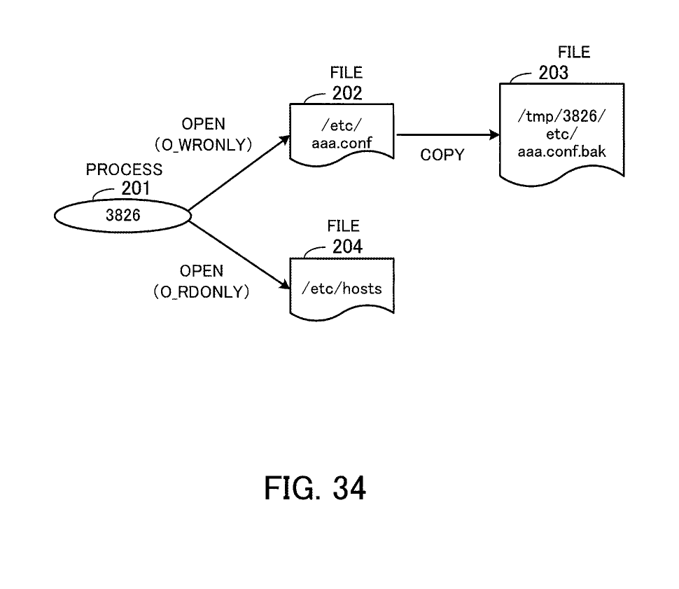

FIG. 34 illustrates an example of copying by the second copy method. For example, when a process 201 opens a file 202 in the O_WRONLY mode, the file 202 is copied, and the copy file 203 is stored in the HDD. Then, a combination of the PID of the process 201, the file path of the file 202, and the file path (copy position) of the file 203 is set in the copy file information 81 (refer to FIG. 18).

On the other hand, when the process 201 opens a file 204 in the O_RDONLY mode, the file 204 is not copied, and the information is not registered in the copy file information 81.

As described above, a copy of a file is created by copying all files that has a possibility of being written, even when it is difficult to hook a system call due to the reason such as system reliability protection.

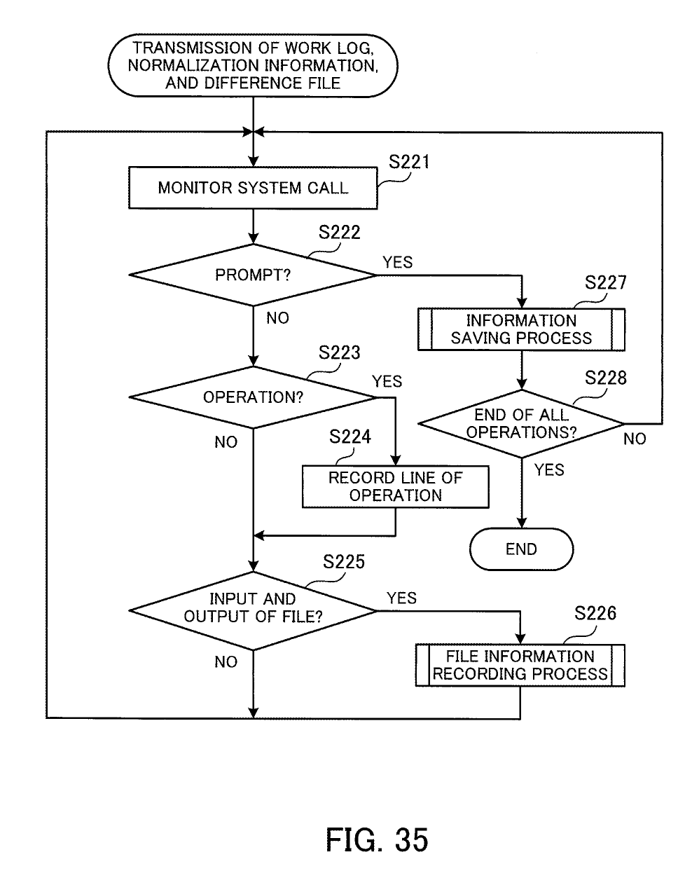

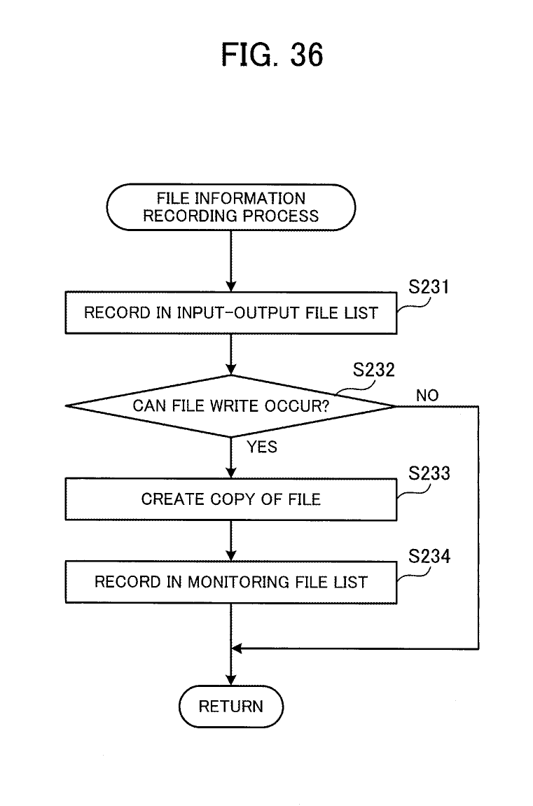

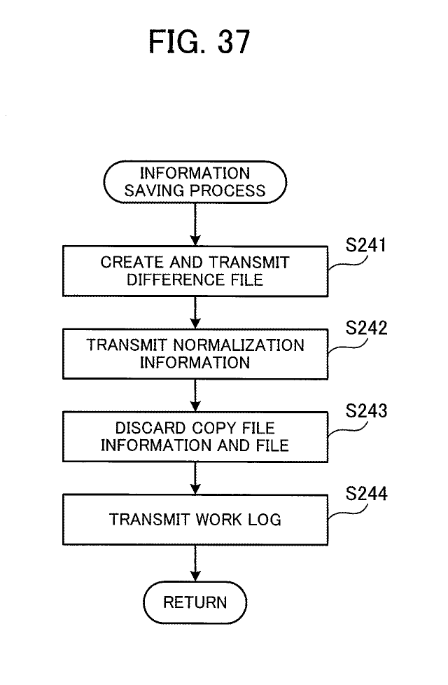

In the following, a procedure of creation and transmission of information by the server 41 in the third embodiment will be described in detail. FIG. 35 is a flowchart illustrating an example of a procedure of a process for transmitting a work log, normalization information, and a difference file.

[Step S221] The server 41 monitors a system call. The system call obtained by the monitoring is recorded in the memory or the HDD as a log.

[Step S222] The server 41 determines whether or not the generated system call includes a character string indicating a prompt (refer to FIG. 8). If the generated system call includes a character string indicating a prompt, the process proceeds to step S227. If the generated system call does not include a character string indicating a prompt, the process proceeds to step S223.

[Step S223] The server 41 determines whether or not the generated system call is an edit operation of a file (refer to FIG. 9). If an edit operation of a file, the process proceeds to step S224. If not an edit operation of a file, the process proceeds to step S225.

[Step S224] The server 41 records the line of the log indicating the edit operation in the memory or the like, as “operation line”.

[Step S225] The server 41 determines whether or not the generated system call indicates an input-output process of a file (refer to FIG. 10). If the generated system call indicates an input-output process of a file, the process proceeds to step S226. If the generated system call does not indicate an input-output process of a file, the process proceeds to step S221.

[Step S226] The server 41 executes a file information recording process for recording file information into the input-output file list and the monitoring file list. The detail of this process will be described later (refer to FIG. 36). Thereafter, the process proceeds to step S221.

[Step S227] If a system call including a character string of a prompt is generated, the server 41 executes an information saving process. The detail of this process will be described later (refer to FIG. 37).

[Step S228] The server 41 determines whether or not all operations have ended. If all operations have ended, the process ends. If all operations have not ended, the process proceeds to step S221.

Next, the detail of the file information recording process (step S226) will be described.

FIG. 36 is a flowchart illustrating an example of the procedure of the file information recording process.

[Step S231] The server 41 records a file name and an attribute of a file of input-output target, in the input-output file list 75 (refer to FIG. 11).

[Step S232] The server 41 determines whether or not the file of input-output target is a file that has a possibility of being written (a file having an attribute of output). If a file that has a possibility of being written, the process proceeds to step S233. If not a file that has a possibility of being written, the list creation process ends.

[Step S233] The server 41 creates a copy of the file of input-output target.

[Step S234] The server 41 records information (a PID, a file path, and a file descriptor) of the file of input-output target, in the monitoring file list 79 (FIG. 16).

In this way, information relevant to the file of input-output target is recorded in the input-output file list 75 and the monitoring file list 79.

Next, the detail of the information saving process (step S227) will be described. FIG. 37 is a flowchart illustrating an example of the procedure of the information saving process.

[Step S241] The server 41 creates a difference file indicating a difference (refer to FIG. 20) between a master file and a file that is copied before editing the master file, on the basis of the copy file information 81 (refer to FIG. 18). Then, the server 41 transmits the difference file to the management server 100. Then, the management server 100 stores the difference file in the difference file database 112.

[Step S242] The server 41 generates the normalization information and transmits it to the management server 100. Then, the management server 100 stores the normalization information in the normalization information database 113.

[Step S243] The server 41 discards the copy file information 81 and the copy file.

[Step S244] The server 41 transmits to the management server 100 the work logs that have not been transmitted. Then, the management server 100 stores the work logs in the work log database 111.

By the above process, a work log, a difference file, and normalization information are transmitted from the server 41 to the management server 100.

Next, the normalization process in the third embodiment will be described. In the third embodiment, normalization is performed by rewriting a graph.

As illustrated in FIG. 4, the graphs 61 to 64 that define the precondition and the postcondition of the operation is created on the basis of the work log, and the graphs 61 to 64 are integrated on the basis of match of conditions, to create the graph 65. Then, as illustrated in FIG. 5, when a server satisfying the initial condition 66 is a work target, the operation procedure 69 for making the server to satisfy the target condition 67 is created, using the graph 65.

As described above, when a work procedure executable in a server is created on the basis of the graphs 61 to 65, the edit operation in the work log is normalized when a graph corresponding to the edit operation is created.

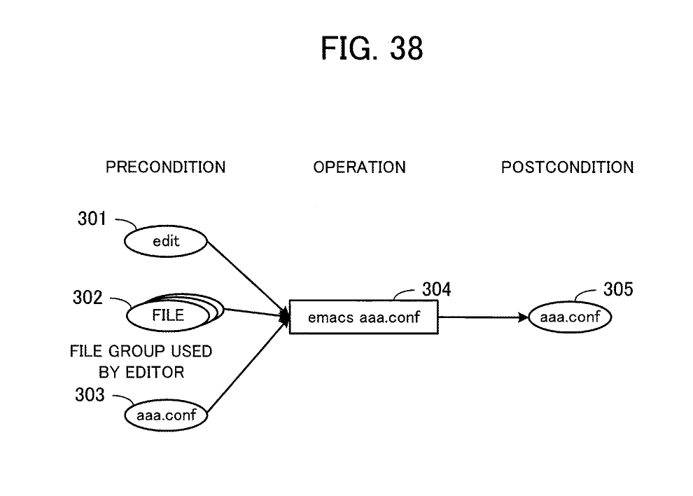

FIG. 38 illustrates an example of a graph created from logs of edit operation. In the graph, nodes 301 to 303 of preconditions are connected to a node 304 indicating an operation from the left, and a node 305 indicating a postcondition is connected to the node 304 from the right. The precondition is a condition that requires the presence of files having an attribute of input, among the input-output file list. The nodes 301 to 303 corresponding to those files are connected to the node 304 indicating the operation. The postcondition is a condition that requires the presence of a file having an attribute of output, among the input-output file list. The node 305 corresponding to the file is connected to the node 304 indicating the operation. This graph is created by the graph creating unit 150 and is stored in the graph database 114.

The normalization unit 140 executes the following process for each entry of the normalization information database 113.

First, the normalization unit 140 selects a graph of normalization target. For example, the normalization unit 140 selects an entry in the normalization information database 113, and acquires the input-output file list and the operation characters in the operation line of the entry. As for the entry of ID “1” of the normalization information database 113 of FIG. 27, “edit aaa.conf” is acquired as the operation characters, and ‘{“/usr/share/emacs/site-lisp/default.el”:“input”, “/etc/aaa.conf”:“output”, . . . }’ is acquired as the input-output file list. Thereafter, the normalization unit 140 selects a graph corresponding to the entry selected in the normalization information database 113, as a replacement target.

The normalization unit 140 acquires a file path (for example, /etc/aaa.conf) and a difference file name (for example, aaa.conf.diff) from the selected entry.

The normalization unit 140 deletes all nodes of precondition from the selected graph. Thereafter, the normalization unit 140 adds the nodes corresponding to the master file before edit, the difference file, the command execution file for creating the file after edit from the difference file and the original file, and the input file group used in the execution of the command, as the precondition of the graph.

The normalization unit 140 deletes all nodes of postcondition of the selected graph. Thereafter, the normalization unit 140 adds the node corresponding to the file path as the file after edit, as the postcondition of the graph.

The normalization unit 140 replaces the node indicating the operation, with a node indicating a command input operation with a normalized operation character string, such as “patch <file path> <difference file name>”.

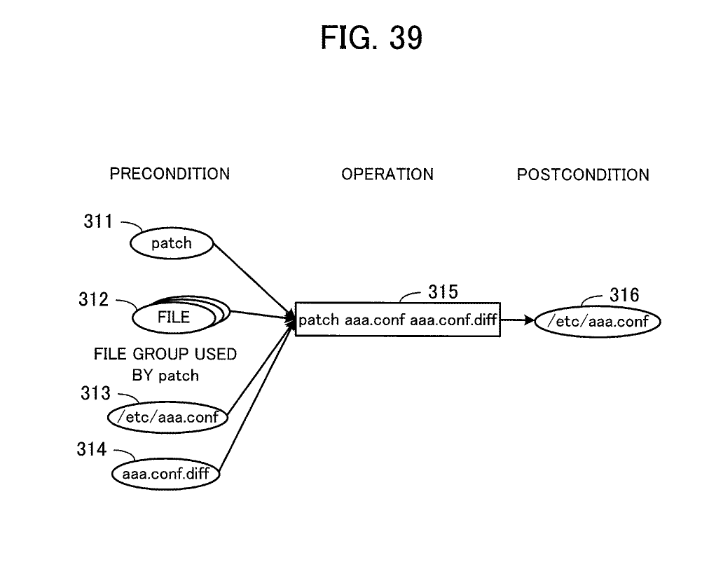

FIG. 39 illustrates an example of a graph after normalization. In the example of FIG. 39, nodes 311 to 314 are set as the precondition. The node 311 indicates a command execution file “patch” for creating a file after edit from a difference file and an original file. The node 312 indicates an input file group (/etc/ld.so.cache, /lib64/libselinux.so.1, /lib64/libc.so.6, . . . ) that is used in the execution of the command. The node 313 indicates a master file “/etc/aaa.conf”. The node 314 indicates a difference file “aaa.conf.diff”. The node 315 indicating the operation indicates an input operation of a command “patch aaa.conf aaa.conf.diff”. The node 316 indicating the postcondition indicates a file after edit “/etc/aaa.conf”.

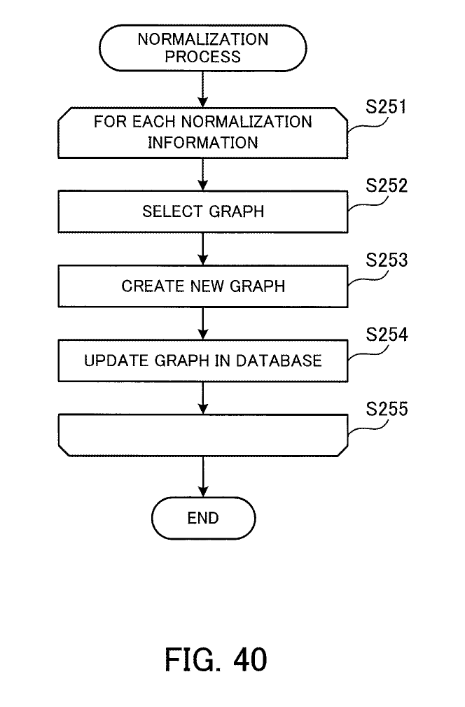

FIG. 40 illustrates an example of a procedure of a normalization process.

[Step S251] The normalization unit 140 executes processes of steps S252 to S254, for each entry (normalization information) of the normalization information database 113.

[Step S252] The normalization unit 140 selects a graph corresponding to an edit operation as a rewrite target.

[Step S253] The normalization unit 140 rewrites the selected graph to automate the edit operation according to the input of the operator (refer to FIGS. 38 and 39).

[Step S254] The normalization unit 140 replaces the graph of the rewrite target in the graph database 114, with the graph rewritten in step S253.

[Step S255] The normalization unit 140 ends the normalization process, when completing the process of steps S252 to S254 with respect to all normalization information.

In this way, the edit operation is normalized by rewriting the graph, without rewriting the log.

Note that each unit illustrated in the above embodiments may be replaced by another element having the same function. Also, other elements and processes may be added arbitrarily. Further, two or more configurations (features) may be combined arbitrarily from the above embodiments.

According to one aspect, a file edit operation is reutilizable to create a work procedure.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A work log editing method comprising:
acquiring at least one operation log in work performed on a management target device and difference information indicating a difference between a file before edit and the file after edit that is edited using an editing software;
extracting, by a processor, a first log indicating an activation operation of the editing software that is used in editing the file, from the operation log; and
replacing, by the processor, the first log with a second log indicating an operation for reflecting in the file the difference indicated in the difference information.

2. The work log editing method according to claim 1, further comprising
detecting, by the management target device, execution of the editing software, and
generating, by the management target device, the difference information indicating the difference between the file before edit and the file after edit that is edited using the editing software.

3. The work log editing method according to claim 2, wherein
the detecting includes monitoring an input from an input device and, when there is an input from the input device while executing an activated software, detecting the activated software as the editing software.

4. The work log editing method according to claim 3, wherein
the detecting includes determining that an input is performed from the input device, when a character string input into a process during execution of the editing software is output as an echo back from the process.

5. The work log editing method according to claim 2, wherein
the generating includes generating the difference information by creating a copy file of the file before edit and comparing the file after edit with the copy file.

6. The work log editing method according to claim 5, wherein
the creating includes creating the copy file before executing a first write into the file, when the first write is detected.

7. The work log editing method according to claim 1, wherein
the replacing includes replacing an instruction for activating the editing software with an instruction for executing a difference reflection process, and replacing designation of a first input file that is used in executing the editing software with designation of a second input file that is used in executing the difference reflection process.

8. The work log editing method according to claim 1, wherein
the replacing includes replacing a first graph with a second graph, the first graph connecting a node of a precondition indicating a state that a first device for executing the editing software is expected to be in, a node of an activation operation of the editing software, and a node of a postcondition indicating a state that the first device that has executed the editing software is expected to be in, the second graph connecting a node of a precondition indicating a state that a second device for executing a difference reflection process is expected to be in, a node of an execution operation of the difference reflection process, a node of a postcondition indicating a state that the second device that has executed the difference reflection process is expected to be in.

9. An information processing apparatus comprising:
a memory configured to store at least one operation log in work performed on a management target device, and difference information indicating a difference between a file before edit and the file after edit that is edited using an editing software; and
a processor configured to perform a procedure including:
extracting a first log indicating an activation operation of the editing software that is used in editing the file, from the operation log, and
replacing the first log with a second log indicating an operation for reflecting in the file the difference indicated in the difference information.

10. A non-transitory computer-readable storage medium storing a computer program that causes a computer to perform a procedure comprising:
acquiring at least one operation log in work performed on a management target device and difference information indicating a difference between a file before edit and the file after edit that is edited using an editing software;
extracting a first log indicating an activation operation of the editing software that is used in editing the file, from the operation log; and
replacing the first log with a second log indicating an operation for reflecting in the file the difference indicated in the difference information.
